(19) United States
(12) Patent Application Publication
(10) Pub. No.: US 2024/0248183 A1
(43) Pub. Date: Jul. 25, 2024

(54) LIGHT DISTANCE MEASUREMENT DEVICE

(71) Applicant: DENSO CORPORATION, Kariya-city (JP)

(72) Inventor: Kenta AZUMA, Kariya-city (JP)

(21) Appl. No.: 18/627,662

(22) Filed: Apr. 5, 2024

Related U.S. Application Data
(63) Continuation of application No. PCT/JP2022/038354, filed on Oct. 14, 2022.

(30) Foreign Application Priority Data
Oct. 25, 2021 (JP) 2021-173995

(51) Int. Cl. G01S 7/487; G01S 7/4863; G01S 7/4865; G01S 7/497; G01S 17/10

(52) U.S. Cl. CPC G01S 7/4873; G01S 7/4863; G01S 7/4865; G01S 17/10; G01S 2007/4975

(57) ABSTRACT

A light distance measurement device detects a distance to a target. The light distance measurement device includes an irradiation unit, photodetectors, a level adjustment unit, a peak detection unit, a pulse information acquisition unit, and a distance calculation unit. The irradiation unit irradiates sensing light in a detection target direction. The photodetectors is arranged in a matrix and responds to the sensing light. The level adjustment unit changes an irradiation intensity of the sensing light or detection sensitivity of the photodetectors. The peak detection unit detects a received light pulse and a peak of the received light pulse. The pulse information acquisition unit acquires, as pulse information, a data set indicating a predetermined feature amount related to the received light pulse. The pulse information includes normal and suppression pulse information. The distance calculation unit calculates a distance value to the target based on the normal and suppression pulse information.

### CROSS REFERENCE TO RELATED APPLICATIONS

The present application is a continuation application of International Patent Application No. PCT/JP2022/038354 filed on Oct. 14, 2022, which designated the U.S. and claims the benefit of priority from Japanese Patent Application No. 2021-173995 filed on Oct. 25, 2021. The entire disclosures of all of the above applications are incorporated herein by reference.

### TECHNICAL FIELD

The present disclosure relates to a light distance measurement device that detects a distance to an object.

### BACKGROUND

A conventional light distance measurement device measures a distance to a target by using a time of flight of light emitted from a light source, reflected by the target, and reaching a sensor.

### SUMMARY OF THE INVENTION

According to at least one embodiment, a light distance measurement device detects a distance to a target by using a round-trip time of light to the target. The light distance measurement device includes an irradiation unit, photodetectors, a level adjustment unit, a peak detection unit, a pulse information acquisition unit, and a distance calculation unit. The irradiation unit irradiates sensing light, which is light having a predetermined wavelength, in a predetermined detection target direction. The photodetectors is arranged in a matrix and responds to the sensing light, The level adjustment unit changes an irradiation intensity of the sensing light output from the irradiation unit or detection sensitivity of the photodetectors from a normal level to a suppression level smaller than the normal level by a predetermined amount. The peak detection unit detects a received light pulse corresponding to reflected light, which is the sensing light reflected by an object and returned, and a peak of the received light pulse, based on time-series data of a number of responses of the photodetector. The pulse information acquisition unit acquires, as pulse information, a data set indicating a predetermined feature amount related to the received light pulse detected by the peak detection unit. The pulse information includes normal pulse information at the normal level and suppression pulse information at the suppression level. The distance calculation unit calculates a distance value to the target based on the normal pulse information and the suppression pulse information.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram illustrating a configuration of a light distance measurement device.

FIG. 2 is a schematic diagram for explaining a configuration of a light receiving array.

FIG. 3 is a diagram illustrating a modification of an allocation mode of a cell group corresponding to each pixel.

FIG. 4 is a diagram illustrating a feature amount of a received light pulse.

FIG. 5 is a diagram for explaining a method of determining a peak arrival time when peak intensity is saturated.

FIG. 6 is a diagram for explaining scattered light of a proximity body.

FIG. 7 is a diagram illustrating for explaining multiple reflected light.

FIG. 8 is a diagram for explaining an influence on a rise determination time and a pulse width according to a type of unnecessary reflected light.

FIG. 9 is a functional block diagram of a controller.

FIG. 10 is a diagram illustrating an operation of the light distance measurement device.

FIG. 11 is a diagram illustrating an example of calculation formulas corresponding to each observation pattern.

FIG. 12 is a diagram illustrating another example of calculation formulas corresponding to each observation pattern.

FIG. 13 is a diagram illustrating other example of calculation formulas corresponding to each observation pattern.

FIG. 14 is a flowchart illustrating a method of determining an observation pattern.

FIG. 15 is a schematic diagram illustrating a difference between the peak arrival time observed in a normal process and the peak arrival time in a suppression process when target reflected light is coupled with the scattered light.

FIG. 16 is a schematic diagram illustrating the difference between the peak arrival time observed in the normal process and the peak arrival time in the suppression process when the target reflected light is coupled with the multiple reflected light.

FIG. 17 is a flowchart illustrating another example of the observation pattern determination method.

FIG. 18 is a flowchart illustrating another example of the observation pattern determination method.

FIG. 19 is a schematic diagram illustrating a difference between the rise determination time observed in the normal process and the peak arrival time in the suppression process when the target reflected light is coupled with the multiple reflected light.

FIG. 20 is a schematic diagram illustrating the difference between the rise determination time observed in the normal process and the peak arrival time in the suppression process when the target reflected light is coupled with the scattered light.

FIG. 21 is a diagram illustrating a modification of a configuration of a light distance measurement device.

### DETAILED DESCRIPTION

To begin with, examples of relevant techniques will be described.

The light distance measurement device of a comparative example measures a distance to a target by detecting a time of flight of light emitted from a light source, reflected by the target, and reaching a sensor. The light distance measurement device of the comparative example includes SPADs for each pixel, and a controller specifies received light intensity for each pixel using the number of SPADs responding to the reflected light from the target. The “SPAD” stands for a “Single Photon Avalanche Diode”. Then, a distance value for each pixel is calculated based on a time from when the light is emitted from the light source to when a peak of the received light intensity is obtained.

The SPAD is a photodetector that uses “avalanche multiplication” in which electrons are amplified like an avalanche from one photon, and is capable of detecting even weaker light than other photodetectors. That is, since the SPAD is capable of reacting to even weak light, light distance measurement device is capable of measuring a distance with a long distance and high accuracy.

However, in the configuration in which the SPAD is used as the photodetector, due to the high responsiveness of the SPAD, the intensity value (that is, a pixel value) of each pixel is likely to be saturated by unnecessary reflected light (so-called clutter) in an actual environment. In addition, the intensity of the sensing light must be increased to extend the measuring range, which is a distance over which an object can be detected. The longer the measuring range is increased, the more likely the pixel values will be saturated with unnecessary reflected light. The state in which the pixel value is saturated refers to a state in which the pixel value reaches an upper limit value of an observable received light intensity range. Further, as the unnecessary reflected light, internal scattered light generated by an object present inside a housing of a light distance measurement device, adhered-matter scattered light which is scattered light due to adhered matter adhering to an outside of an irradiation window, multiple reflected light, and the like are assumed.

A determine whether observed received light pulse is caused by the reflected light from the target, the unnecessary reflected light, or a combination of the reflected light from the target and the unnecessary reflected light when the unnecessary reflected light at a level at which the pixel value is saturated is received. If the entire received light pulse in which the unnecessary reflected light and the reflected light from the target are combined is regarded as the reflected light from the target, an error occurs in a feature amount such as a peak position or a rising position corresponding to the reflected light from the target, and the position of the target may be erroneously determined.

In contrast to the comparative example, according to a light distance measurement device of the present disclosure, a risk of incorrectly calculating a distance to a target can be reduced without reducing a measuring range.

According to one aspect of the present disclosure, a light distance measurement device detects a distance to a target by using a round-trip time of light to the target. The light distance measurement device includes an irradiation unit, photodetectors, a level adjustment unit, a peak detection unit, a pulse information acquisition unit, and a distance calculation unit. The irradiation unit irradiates sensing light, which is light having a predetermined wavelength, in a predetermined detection target direction. The photodetectors is arranged in a matrix and responds to the sensing light, The level adjustment unit changes an irradiation intensity of the sensing light output from the irradiation unit or detection sensitivity of the photodetectors from a normal level to a suppression level smaller than the normal level by a predetermined amount. The peak detection unit detects a received light pulse corresponding to reflected light, which is the sensing light reflected by an object and returned, and a peak of the received light pulse, based on time-series data of a number of responses of the photodetector. The pulse information acquisition unit acquires, as pulse information, a data set indicating a predetermined feature amount related to the received light pulse detected by the peak detection unit. The pulse information includes normal pulse information at the normal level and suppression pulse information at the suppression level. The distance calculation unit calculates a distance value to the target based on the normal pulse information and the suppression pulse information.

According to this configuration, the distance to the target is calculated using not only the normal pulse information, which is the pulse information observed when the normal level is applied, but also the suppression pulse information, which is the pulse information observed when the suppression level is applied. When the suppression level is applied, since the irradiation intensity or the detection sensitivity of the sensing light is reduced as compared with the normal level, the phenomenon in which the pixel value is saturated by the unnecessary reflected light is less likely to occur. Accordingly, the waveform of the received light pulse differs among a case where the reflected light from the target is received, a case where only the unnecessary reflected light is received, and a case where the reflected light from the target and the unnecessary reflected light are combined. Therefore, by using the normal pulse information and the suppression pulse information together, it is possible to determine whether the observed received light pulse is caused by the reflected light from the target, the unnecessary reflected light, or the combination of the reflected light from the target and the unnecessary reflected light. Further, by using not only the suppression pulse information but also the normal pulse information, a relatively distant target can also be detected. That is, it is possible to reduce the possibility of erroneously calculating the distance to the target without reducing the distance measuring range.

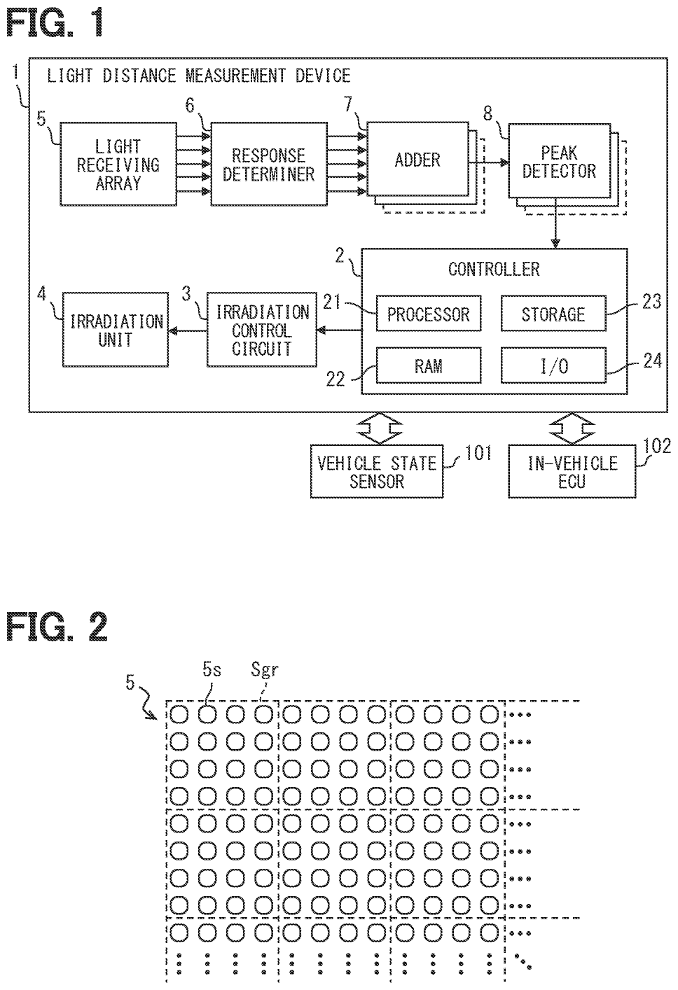

Hereinafter, an embodiment of the present disclosure will be described with reference to the drawings. A light distance measurement device 1 shown in FIG. 1 is an apparatus that measures a distance to a target based on a round-trip time of light to a target. The light distance measurement device 1 is also referred to as a LiDAR. The LiDAR stands for Light Detection and Ranging/Laser Imaging Detection and Ranging. The target in the present disclosure refers to various objects that are capable of reflecting light. The target may be a feature/moving object that is an entity independent of a host vehicle, such as another vehicle, a pedestrian, a median strip, or a guardrail, and may be an obstacle in travel control of the host vehicle. The host vehicle in the present disclosure refers to a vehicle on which the light distance measurement device 1 is mounted.

The light distance measurement device 1 includes an irradiation unit 4 that irradiates sensing light, which is pulsed light, and a light receiving array 5 in which a plurality of light receiving elements are arranged in an array. The light distance measurement device 1 generates a distance image as data indicating a distance measurement result based on a time (so-called ToF: Time of Flight) from irradiation of sensing light by the irradiation unit 4 to reception of reflected light corresponding to the sensing light by each light receiving element.

The distance image includes pixels, and is data in which a value of each pixel indicates a distance to an object. As shown in FIG. 1, the light distance measurement device 1 is connected to a vehicle state sensor 101 and an in-vehicle ECU 102. In the present disclosure, the ECU is used as an abbreviation for electronic control unit, and indicates any kind of electronic control device. The light distance measurement device 1 is connected to the vehicle state sensor 101 and the in-vehicle ECU 102 via an in-vehicle network. Of course, the light distance measurement device 1 may be directly connected to some of sensors/ECUs using a dedicated communication line.

An irradiation pattern of the sensing light in the light distance measurement device 1 may be a scanning method or a flash method. The scanning method refers to a method of sweeping and irradiating the sensing light by dynamically changing an angle of a reflecting mirror with respect to the irradiation unit 4 using an actuator. The scanning direction may be a horizontal direction or a vertical direction. The flash method is a method of irradiating diffused sensing light at a time in an angle range corresponding to a desired detection range. The present disclosure is applicable to both the scanning method and the flash method.

The vehicle state sensor 101 is a sensor for detecting information on behavior of the host vehicle and information on a driving operation that affects the behavior of the host vehicle (hereinafter referred to as vehicle information). The vehicle information includes, for example, a traveling speed of the host vehicle, an acceleration acting on the host vehicle, a yaw rate, a pedal operation amount, and a steering angle. The pedal operation amount indicates a depression amount or depression force of each of an accelerator pedal and a brake pedal. A signal indicating a state of a vehicle power supply can also be included in the vehicle information. The state of the vehicle power supply includes whether a traveling power source is turned on. The traveling power source is a power supply for travel of the vehicle, and refers to an ignition power source when the host vehicle is a combustion engine vehicle. If the host vehicle is an electric vehicle, the traveling power source refers to a system main relay. The electric vehicle includes not only an electric vehicle but also a plug-in hybrid vehicle, a hybrid vehicle, and the like. Vehicle state sensors 101 having different detection targets can be connected to the light distance measurement device 1. The vehicle state sensor 101 outputs a signal indicating a detection result to the light distance measurement device 1.

The in-vehicle ECU 102 is an optional ECU mounted on the host vehicle. For example, the light distance measurement device 1 is used by being connected to a driving assistance ECU or the like. The driving assistance ECU is an ECU that executes a process of supporting the driving operation of a driver. The driving assistance ECU provides the driver with collision warnings of another moving object or a stationary object based on the detection result of the light distance measurement device 1. The driving assistance ECU may be an ECU that performs not only information presentation but also automatic braking control or steering according to the detection result of the light distance measurement device 1. The other moving object refers to a pedestrian, another vehicle, a cyclist, or the like. The driving assistance ECU may be an automatic operation device that causes the vehicle to autonomously travel to a destination set in advance. The driver in the present disclosure refers to a person sitting on a driver's seat, that is, a driver's seat occupant. The driver in the present disclosure is a person who should receive driving operation authority from the automated driving system during automated driving. A concept of the driver can include an operator who remotely operates the vehicle.

### <Configuration of Light Distance Measurement Device 1>

As shown in FIG. 1, the light distance measurement device 1 includes a controller 2, an irradiation control circuit 3, the irradiation unit 4, the light receiving array 5, a response determiner 6, an adder 7, and a peak detector 8. In addition, as illustrated separately, the light distance measurement device 1 includes a housing 9 that accommodates these components. The housing 9 is provided with an irradiation window 91 for irradiating sensing light. The irradiation window 91 is realized by using a member having translucency, for example, a transparent resin panel or glass. The irradiation window 91 can also function as a window for the light receiving array 5 to receive reflected light from a target. The irradiation window 91 and the window portion for light reception may be provided separately. The irradiation window 91 may also be referred to as an optical window.

The controller 2 controls the light distance measurement device 1. The controller 2 inputs a signal related to an irradiation setting of the sensing light to the irradiation control circuit 3. In addition, the controller 2 acquires pulse information of the received light pulse corresponding to the reflected light from the peak detector 8. The controller 2 is implemented by using a processor 21, a random access memory (RAM) 22, and a storage 23. The controller 2 includes a digital signal processor (DSP), a central processing unit (CPU), and the like as the processor 21. Various functions of the controller 2 are realized by the processor 21 executing a program stored in the storage 23. The functions of the controller 2 will be described later.

The irradiation control circuit 3 causes the irradiation unit 4 to irradiate the sensing light at a predetermined irradiation interval based on a command from the controller 2. The irradiation control circuit 3 controls a pulse width, irradiation intensity, an irradiation interval, and the like of the sensing light irradiated from the irradiation unit 4. The irradiation intensity corresponds to a peak height (so-called peak power) of a pulsed light output as the sensing light. In the present disclosure, the sensing light emitted from the irradiation unit 4 is also referred to as irradiation light in order to be distinguished from the sensing light received as reflected light. The pulse width of the irradiation light is set to, for example, 5 nanoseconds. Of course, the pulse width of the irradiation light may be 20 nanoseconds, 10 nanoseconds, or 1 nanosecond. The pulse width of the irradiation light may be set to a value less than 1 nanosecond, such as 50 picoseconds, 100 picoseconds, or 200 picoseconds.

The irradiation control circuit 3 is configured to switch the irradiation intensity of the sensing light between a normal level and a suppression level. The normal level is set to a predetermined value for realizing a desired distance measuring range. The distance measuring range corresponds to a detectable distance that is a distance at which a predetermined object set as a target can be detected. For example, the normal level is set to an intensity capable of realizing the distance measuring range of about 250 m or 300 m. The suppression level is set to a value of about 1/50 of the normal level. The suppression level may be 1/10, 1/100, 1/200, or 1/1000 of the normal level. The suppression level is set to a value, such as within 3 m, at which an object in a nearby region described later can be detected. An adjustment of the irradiation intensity may be realized by using a variable gain amplifier capable of adjusting an amplification degree, or may be realized by switching a drive voltage of the irradiation unit 4. A switching between the normal level and the suppression level may be realized by switching the light source itself, the number of light sources, or the like. That is, a light source for the normal level and a light source for the suppression level may be separately prepared, and the irradiation control circuit 3 may be configured to be able to alternately/selectively perform irradiation at the normal level and irradiation at the suppression level by selectively using the light sources.

The irradiation unit 4 includes, for example, a laser diode serving as a light source, and irradiates light having a predetermined wavelength as sensing light from the light source in a predetermined detection target direction. The detection target direction corresponds to a region in which a target as a distance measurement target is to be detected. In a scanning-type light distance measurement device 1, the detection target direction may be dynamically changed using a mirror or the like. In a flash-type light distance measurement device 1, the detection target direction can have a predetermined angular range in an up-down direction and a left-right direction.

The sensing light is infrared light, but may be visible light. For example, the sensing light is light belonging to a band of 900±50 nm which is general as laser light. The irradiation unit 4 may be configured to output laser light having a wavelength of 1400 nm or more, such as 1550 nm. According to the configuration in which an electromagnetic wave of 1400 nm or more is adopted as the sensing light, resistance (for example, a signal-to-noise ratio) to white noise such as sunlight is easily increased. In addition, from a viewpoint of human body protection, there is an advantage that a power limit defined by the IEC (International Electrotechnical Commission) is capable of reducing.

The light receiving array 5 includes light receiving cells 5s capable of outputting a pulse signal in response to incidence of reflected light from an object. Each of the light receiving cells 5s includes a SPAD (Single Photon Avalanche Diode) as a light receiving element. The SPAD is a type of avalanche photodiode. The SPAD operates by applying a voltage higher than a breakdown voltage as a reverse bias voltage. The light receiving cells 5s are configured to detect a voltage change when the SPAD breaks down due to incidence of a photon and output a digital pulse (hereinafter referred to as a pulse signal) having a predetermined pulse width.

For example, each of the light receiving cells 5s includes a quench circuit connected in series to the SPAD as the light receiving element. The quench circuit may be, for example, a resistive element (so-called quench resistor) having a predetermined resistance value, a metal oxide semiconductor field effect transistor (MOSFET), or the like. Each of the light receiving cells 5s outputs a digital pulse having a value of zero as the above-described pulse signal when the SPAD breaks down and an electric current flows through the quench circuit. In this manner, each of the light receiving cells 5s outputs the pulse signal when the SPAD responds. The light receiving cells 5s correspond to a photodetector.

The light receiving cells 5s are arranged in a two-dimensional matrix (lattice or grid). For example, the light receiving array 5 is configured as a silicon photo multiplier (SiPM) in which the light receiving cells 5s are arranged in an array. The number of rows and the number of columns of the light receiving arrays 5 are appropriately designed based on the required resolution/number of pixels. The value of a certain pixel constituting the distance image is determined by the number of responses among the light receiving cells 5s assigned to the pixel in advance. In other words, the light receiving cells 5s form one set to constitute one pixel. FIG. 2 shows a case where 16 (4×4) light receiving cells 5s constitute one pixel. Broken lines in FIG. 2 indicate boundaries of pixels. The number of light receiving cells 5s constituting one pixel is not limited to 16, and may be 64, 128, 256, or the like. The value of one pixel may be determined based on the outputs of 128 light receiving cells 5s (8×16).

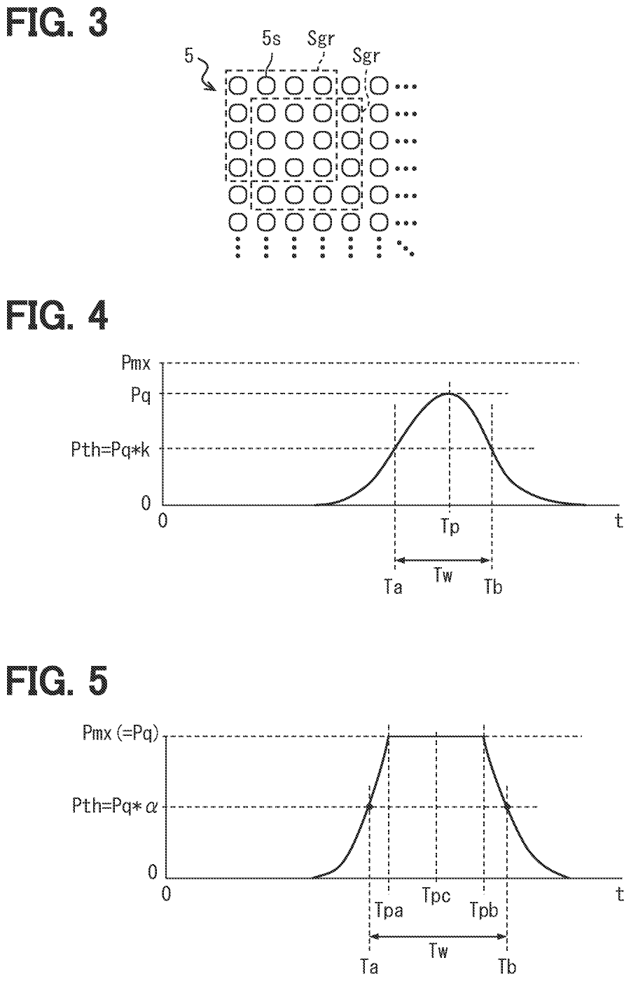

In the present disclosure, a group of the light receiving cells 5s corresponding to one pixel is also referred to as a cell group Sgr. A size of the cell group Sgr corresponds to a size of one element (i.e., pixel) constituting the distance image. Each of cell groups Sgr outputs 0 to 16 pulse signals according to intensity of the received light. FIG. 2 shows an aspect in which the individual pixels are set not to share the light receiving cell 5s, but the invention is not limited thereto. As shown in FIG. 3 as another aspect, each cell group Sgr may be configured to overlap another adjacent cell group Sgr. That is, one light receiving cell 5s may belong to a plurality of cell groups Sgr. A shape of the cell group Sgr is not limited to a square and may be a rectangular shape. That is, the number of rows and the number of columns of the light receiving cells 5s corresponding to one pixel may be different. The light receiving array 5 includes, for example, the number of light receiving cells 5s capable of generating the distance image of one million pixels.

The light receiving array 5 is switched to a light receiving state capable of detecting light by a control signal from the controller 2. For example, the controller 2 outputs a signal instructing irradiation of the sensing light to the irradiation control circuit 3 and inputs a predetermined control signal to the light receiving array 5 to drive each light receiving cell 5s for a certain period of time. As another aspect, each light receiving cell 5s may be configured to always maintain a driving state capable of responding according to the intensity of incident light.

The response determiner 6 determines whether the pulse signal is input from the light receiving cells 5s, that is, whether the SPAD is responding. The response determiner 6 is provided for each of the light receiving cells 5s. The response determiner 6 samples an output of the light receiving cells 5s at a predetermined clock frequency. The response determiner 6 outputs a high level when the light receiving cells 5s respond, and output a low level when the light receiving cells 5s do not respond. The response determiner 6 may be integrally formed with the light receiving cells 5s and the light receiving array 5.

The adder 7 adds and outputs the pulses output from response determiners 6. The adder 7 is provided for each pixel, in other words, for each cell group Sgr. The adder 7 may be implemented as software or may be implemented as hardware. Further, for example, adders 7 may be implemented by using a FPGA (Field-Programmable Gate Array), an ASIC (Application Specific Integrated Circuit), or the like. The same applies to the peak detector 8 described later.

The output of the adder 7 indicates the number of responses of the light receiving cells 5s in the cell group Sgr corresponding to the adder 7. In the present disclosure, the output from the adder 7 is also referred to as a received light intensity or a level value. The level value can also be said to be a value indicating the intensity of the incident light. Therefore, the output level of each adder 7 indicates the received light intensity at each pixel.

As described above, each of the light receiving cells 5s constituting the light receiving array 5 outputs the pulse signal at a frequency corresponding to an amount of ambient light. For this reason, the number of pulse signals output per unit time from the light receiving cell 5s, that is, a pulse rate significantly increases when the reflected light from the target is incident on the light receiving cell 5s. Accordingly, the output level of the adder 7 can also change in a pulse shape at a timing corresponding to the reception of the reflected light. For convenience, a series of signal sequences whose peaks exceed a predetermined level is referred to as the received light pulse.

The peak detector 8 detects a peak of the received light intensity based on time-series data of the received light intensity output from the adder 7. The peak corresponds to a time point at which the received light intensity increases and then decreases. The peak detector 8 is provided for each adder 7, in other words, for each pixel. The peak detector 8 generates, for example, a histogram indicating the received light intensity (level value) for each time. The generated histogram is held in a predetermined format such as a table in a memory (not shown) or the RAM 22.

As shown in FIG. 4, the peak detector 8 detects the received light pulse and the peak thereof based on the time-series data (histogram) of the level value, and acquires pulse information associated with the peak. Since the received light pulse and the peak correspond to each other on a one-to-one basis, the description of the received light pulse in the following description can be understood by being replaced with the peak. The pulse information includes, for example, a peak intensity Pq, a peak arrival time Tp, a rise determination time Ta, a fall determination time Tb, and a pulse width Tw. It can be understood that the peak detector 8 is configured to extract a feature amount of the received light pulse. In the present disclosure, a series of processes of emitting sensing light and acquiring the pulse information for each pixel as a light reception result within a certain time from the emission is also referred to as a light-reception-emission process. The light-reception-emission process can be referred to as a light-emission-reception process based on the order of actions to be performed. The light-reception-emission process can also be referred to as sensing processing or scan processing.

The peak intensity Pq indicates an intensity (that is, a peak value) at the time when the intensity in the waveform becomes maximum. The peak intensity Pq corresponds to a value immediately before the received light intensity starts to decrease, in other words, the intensity at a time point when a slope becomes 0. Here, the slope corresponds to a temporal change rate of the received light intensity. If the intensity of the received light pulse reaches a measurement upper limit value Pmx as shown in FIG. 5, the measurement upper limit value Pmx is the peak intensity Pq. The measurement upper limit value Pmx corresponds to a maximum value of a range of values that can be output by the adder 7. The measurement upper limit value Pmx corresponds to the number of light receiving cells 5s constituting the cell group Sgr. If the number of light receiving cells 5s constituting one cell group Sgr is 256, the sensor upper limit value is 256.

The rise determination time Ta shown in FIGS. 4 and 5 indicates a timing at which the received light intensity reaches a determination threshold Pth in a rising section, in other words, the rise determination time Ta is an elapsed time from when the sensing light is emitted until the received light intensity reaches the determination threshold Pth. The rise determination time Ta can also be referred to as a threshold arrival time. The rise determination time Ta corresponds to a rising position of the received light pulse. The fall determination time Tb shown in FIGS. 4 and 5 indicates a timing at which the received light intensity becomes the determination threshold Pth in a falling section, in other words, the fall determination time which is an elapsed time until the received light intensity becomes lower than the determination threshold Pth. The fall determination time Tb can also be referred to as a subthreshold time. The fall determination time Tb corresponds to the falling position of the received light pulse. In the present disclosure, a time point at which the received light intensity becomes the determination threshold Pth in the rising section is also referred to as a rising point, and a time point at which the received light intensity becomes the determination threshold Pth in the falling section is also referred to as a falling point.

The determination threshold Pth is set to a value obtained by multiplying an actually observed peak intensity Pq by a predetermined coefficient k. As a value of the coefficient k, for example, 0.45, 0.50, 0.55, 0.60, or the like is adopted. Here, k=0.55 (corresponding to 55%) is set as an example. The determination threshold Pth is a parameter that defines a so-called half-value point, which is a timing at which the received light intensity becomes half the peak. Here, the half-value point is not limited to a point at which it is exactly 50%, and may be a point at which it is 45%, 60%, or the like as described above.

The received light intensity output from the adder 7 may include a stationary noise component that is stationary noise due to sunlight or the like. Therefore, the peak intensity Pq can be a value in which the stationary noise component is superimposed on the target reflected light component. If 50% of a raw value of the peak intensity Pq is regarded as the rising position, the rising position is determined at a point lower than a true rising position due to the stationary noise component. The peak detector 8 may dynamically adjust the coefficient k according to a magnitude of a steady disturbance component due to sunlight or the like so that the half-value point of a pure target reflected light component can be detected as the rising position/falling position. For example, the coefficient k may be set to a larger value as the stationary noise component is larger. Alternatively, when the magnitude of the stationary noise component is Pn, the peak detector 8 may detect a point of (Pq−Pn)·k+Pn as the rising position and the falling position. The magnitude of the stationary noise component can be determined based on the received light intensity before irradiation of the sensing light. In addition, the peak detector 8 may determine the peak intensity Pq, the rising position/falling position, and the like based on the time-series data of the corrected received light intensity obtained by removing the stationary noise component from the output value of the adder 7.

An upper limit arrival time Tpa shown in FIG. 5 indicates a time at which the intensity reaches the measurement upper limit value Pmx in the waveform. An upper limit deviation time Tpb indicates a time immediately before the intensity starts to decrease (deviates) from the measurement upper limit value Pmx in the waveform. The upper limit deviation time Tpb is a time point corresponding to a latest time in a period in which the received light intensity is saturated. More specifically, the upper limit deviation time Tpb corresponds to a time point one bin/one frame before a time point at which the received light intensity deviates from the measurement upper limit value Pmx. An intermediate time Tpc indicates a time point located between the upper limit arrival time Tpa and the upper limit deviation time Tpb. In the present disclosure, an observation point corresponding to the upper limit arrival time Tpa is also referred to as an upper limit arrival point, and an observation point corresponding to the upper limit deviation time Tpb is also referred to as a falling start point or an upper limit deviation point.

The peak arrival time Tp is an elapsed time from when the sensing light is emitted to when the peak intensity Pq is observed. The peak arrival time Tp can be expressed by the number of clocks from the irradiation of the sensing light to the observation of the peak intensity Pq. The peak arrival time Tp indicates a peak position on a time axis. If the peak detected by the peak detector 8 corresponds to the reflected light from the target, the peak arrival time Tp corresponding to the peak corresponds to the time of flight (ToF) to the target. Therefore, the controller 2 is capable of calculating the distance to the target for each pixel by multiplying the peak arrival time Tp by C/2. “C” is the speed of light.

As shown in FIG. 5, in a case where the true peak is unclear because the received light intensity reaches the measurement upper limit value Pmx, the peak detector 8 adopts the intermediate time Tpc as the peak arrival time Tp. As another aspect, the peak detector 8 may adopt the upper limit arrival time Tpa as the peak arrival time Tp. The peak detector 8 may estimate the peak arrival time Tp based on the slope at the determination threshold Pth in the rising section and the slope at the determination threshold Pth in the falling section.

The pulse width Tw is a parameter indicating a width of the received light pulse. The pulse width Tw corresponds to a length of time during which the received light intensity is equal to or greater than the determination threshold Pth. That is, the pulse width Tw can be specified by subtracting the rise determination time Ta from the fall determination time Tb. As described above, the determination threshold Pth can be dynamically determined according to the peak intensity, for example, 50% of the maximum intensity in the waveform. In addition, considering that the stationary noise component is superimposed on the output of the adder 7, a method of calculating the determination threshold Pth and the rising/falling position is designed so that the peak detector 8 can calculate (evaluate) the pulse width of a pure target reflected light component.

Various parameters such as the peak intensity Pq, the peak arrival time Tp, the rise determination time Ta, the falling determination time Tb, and the pulse width Tw correspond to feature amounts of the received light pulse. The upper limit arrival time Tpa, the upper limit deviation time Tpb, and the like may also be included in the feature amounts of the received light pulse. The peak detector 8 does not necessarily have to acquire all the parameters described above as detected object information. The peak detector 8 may acquire only a predetermined parameter necessary for the distance calculation processing among all the parameters described above. The “acquisition” of the present disclosure also includes generation/detection by an internal operation.

A plurality of received light pulses (peaks) may appear in one pixel. For example, in addition to a case in which reflected light from different objects reaches the same pixel, a case in which adhered-matter scattered light is received, a case in which the internal scattered light is received, a case in which multiple reflection occurs between targets separated to some extent, and the like are included.

The peak detector 8 of the present embodiment outputs the pulse information on the received light pulse having a largest peak intensity Pq among the received light pulses when the received light pulses are detected in one light-reception-emission process. The operation of the peak detector 8 is not limited to this, and the feature amounts may be calculated for each received light pulse and output as the pulse information. For example, a selection of the peak information for each observed received light pulse may be executed by the controller 2 instead of the peak detector 8. For example, the peak detector 8 may output the pulse information on the received light pulses having the top two peak intensities Pq.

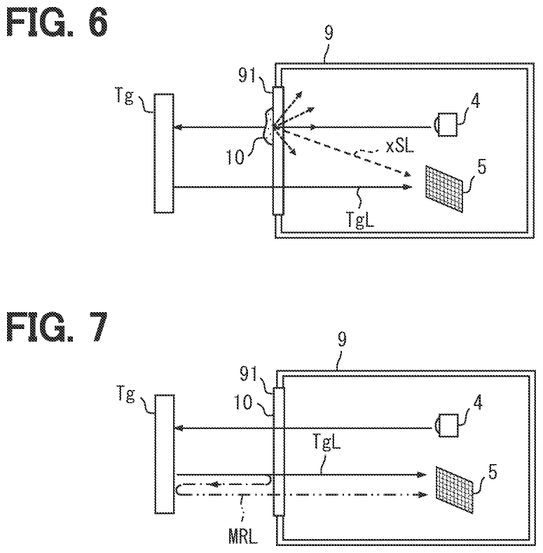

As indicated by “xSL” in FIG. 6, the adhered-matter scattered light of the present disclosure refers to sensing light reflected/scattered by an adhered matter 10 that is an object adhering to the irradiation window 91. The irradiation window 91 is a window portion for outputting light from the light source to the outside of the housing 9. Since the irradiation window 91 also corresponds to a part of the housing 9, the adhered matter 10 can be regarded as a matter attached to the housing 9. The adhered matter 10 is, for example, mud, sand dust, raindrops, bird droppings, or the like. That is, the adhered-matter scattered light refers to light reflected by raindrops, mud, or the like adhering to an outer surface of the irradiation window 91.

The internal scattered light refers to light reflected by an inner surface of the irradiation window 91 or a component in the housing 9. Note that “TgL” in each drawing indicates target reflected light which is reflected light from the target. In the present disclosure, scattered light by a sensor proximity body, such as the adhered-matter scattered light or the internal scattered light, is also referred to as proximity body scattered light or simply scattered light. The sensor proximity body is an object present within 0.1 m from the irradiation unit 4, and indicates the irradiation window 91, a component in the housing 9, the adhered matter 10 to the irradiation window 91, and the like. If the light distance measurement device 1 is used by being attached to a surface of a windshield on the indoor side, the windshield can also be the sensor proximity body.

In addition, as indicated by “MRL” in FIG. 7, the multiple reflected light in the present disclosure refers to light that is a part of the reflected light from the target reflected by the housing 9 of the light distance measurement device 1, the vehicle body, or a peripheral object and is reflected again by the target and returns. A dash-dot-dash line shown in FIG. 7 indicates re-emission which is light obtained by reflecting a part of the target reflected light by the housing 9 or the like of the light distance measurement device 1. A two-dot chain line shown in FIG. 7 indicates the multiple reflected light, that is, double reflected light that is re-emitted light reflected by the target and returned. In the present disclosure, the proximity body scattered light and the multiple reflected light are also collectively referred to as unnecessary reflected light.

The pulse width of the sensing light is as short as several nanoseconds. In view of such circumstances, the target pulse, which is the received light pulse corresponding to the target reflected light, and the noise pulse, which is the received light pulse corresponding to the unnecessary reflected light, can be separated when the target is sufficiently away from the irradiation window 91. However, the target pulse and the noise pulse may be combined when the target exists in a region near the light distance measurement device 1. More specifically, the received light pulse corresponding to the adhered-matter scattered light or the internal scattered light can be combined with the target pulse so as to be located in front of the target pulse on the time axis. This is because the irradiation window 91, the adhered matter 10, and the like are present at positions closer to the light receiving array 5 than the target. The received light pulse corresponding to the multiple reflected light can be combined with the target pulse in such a manner as to be located behind the target pulse on the time axis. This is because an optical path length is longer by the amount of multiple reflection.

In addition, due to the high responsiveness of the SPAD, in an actual environment, the intensity value of each pixel (that is, the pixel value) may be saturated by unnecessary reflected light (so-called clutter). A state in which the pixel value is saturated refers to a state in which the output level of the adder 7 reaches the measurement upper limit value Pmx.

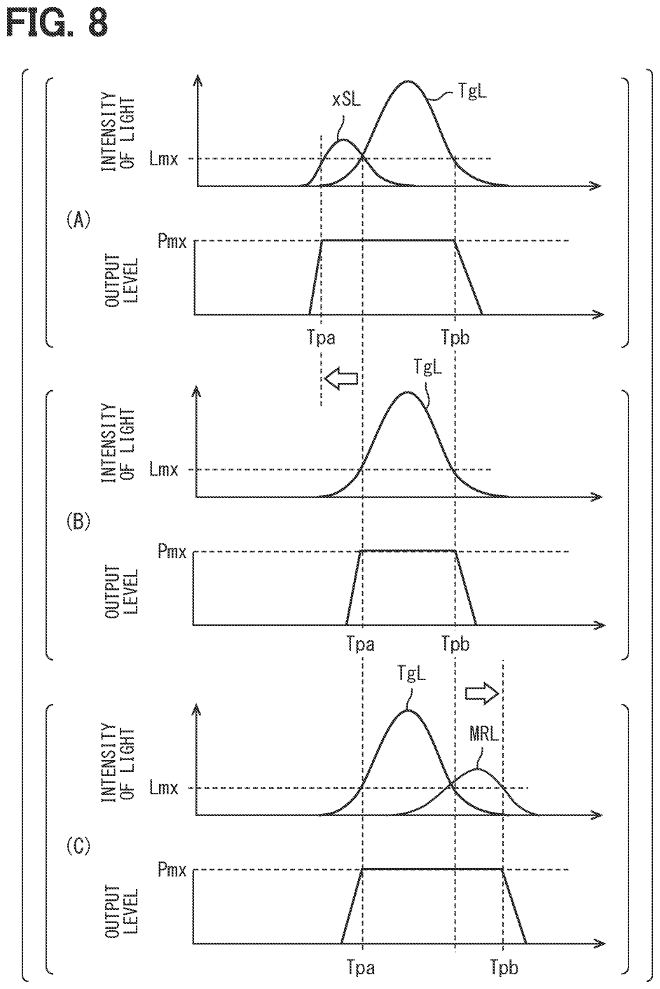

FIG. 8 (A) conceptually shows a transition of the intensity output when the received light pulse corresponding to the proximity body scattered light is coupled with the target pulse. FIG. 8 (C) conceptually shows a transition of the intensity output when the received light pulse derived from the multiple reflected light is coupled with the target pulse. FIG. 8 (B) shows a transition of the intensity output in a case where there is no influence of the unnecessary reflected light. The case where there is no influence of the unnecessary reflected light indicates a case where the unnecessary reflected light is not superimposed (coupled) on the target reflected light (the target pulse).

In each of FIGS. 8 (A), 8 (B), and 8 (C), an upper graph shows the transition of the intensity of light incident on the light receiving array 5, and a lower graph shows the transition of the output level of the adder 7. It is assumed that the intensity of the incident light has a waveform shape having one vertex as shown in the upper graph of FIG. 8 (B), but the output level may have a trapezoidal shape since the adder 7 has the measurement upper limit value Pmx.

As can be seen by comparing FIGS. 8 (A) and 8 (B), the rising point or the upper limit arrival point shifts to the front when the target reflected light is coupled with the proximity body scattered light. As a result, the distance to the target can be calculated to be shorter than the actual distance. On the other hand, the falling point and the upper limit deviation point shift backward when the target reflected light is coupled with the multiple reflected light. In either case, the pulse width Tw itself becomes long.

The true feature amount of the received light pulse corresponding to the target reflected light becomes unclear, and the position of the target may be erroneously determined when the received light pulse due to the unnecessary reflected light and the target pulse are combined as described above. That is, the distance to the target can be calculated to be shorter/longer than the actual distance. The light distance measurement device 1 of the present disclosure has been created in view of the above issue, and incorporates a process of improving distance measurement accuracy by changing at least one of a parameter and a calculation formula used for arithmetic processing on the basis of an observation result of the light-reception-emission process at a normal/suppression level.

The region in the vicinity of the light distance measurement device 1 is a range in which the noise pulse and the target pulse can be combined. The vicinity region refers to a range less than a predetermined vicinity distance determined according to the pulse width of the irradiation light from the light distance measurement device 1. The vicinity distance can be a value obtained by adding a predetermined value determined according to response characteristics of the circuit to half of the distance obtained by multiplying the pulse width of the irradiation light by the speed of light. The response characteristics of the circuit include a recharge time (dead time) of the SPAD. For example, assuming that the pulse width is several nanoseconds, the vicinity distance can be set to about 2 m to 3 m. A state in which the target is sufficiently away from the light distance measurement device 1 corresponds to a state in which the target is present outside the vicinity region.

### Function and Operation of Controller

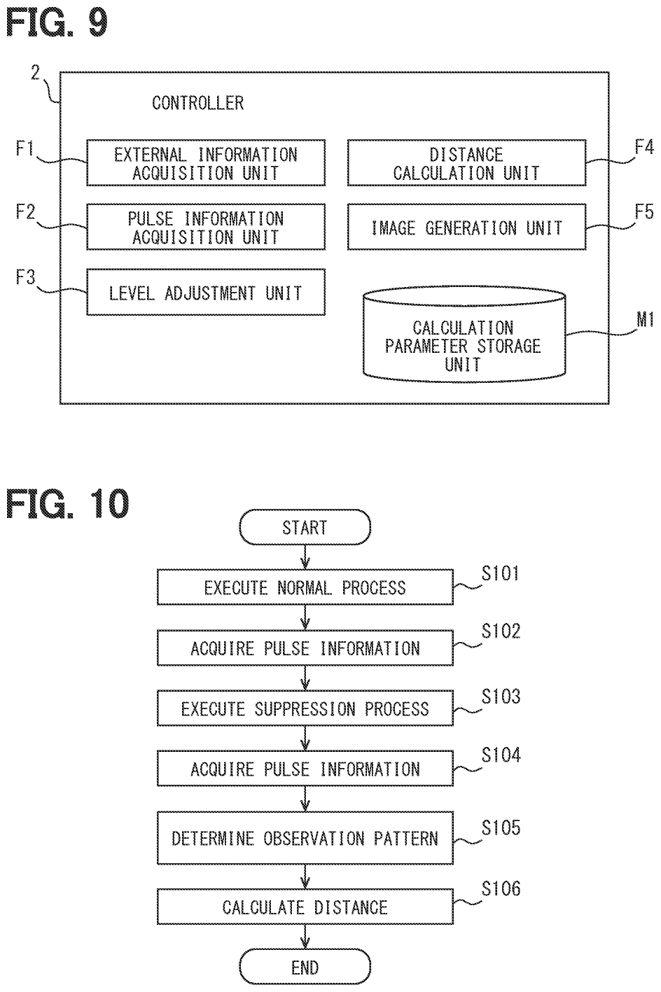

The controller 2 provides functions corresponding to various functional blocks shown in FIG. 9 by executing the program stored in the storage 23. That is, the controller 2 includes, as functional blocks, an external information acquisition unit F1, a pulse information acquisition unit F2, a level adjustment unit F3, a distance calculation unit F4, and an image generation unit F5. The controller 2 includes a calculation parameter storage unit M1.

The calculation parameter storage unit M1 is a storage unit in which various parameters used in distance calculation processing described later are stored. The parameter used for the distance calculation processing is a rising offset value or the like. The calculation parameter storage unit M1 is implemented using a part of the storage area of the storage 23, for example. The calculation parameter storage unit M1 may be realized by using a non-volatile storage medium physically independent of the storage 23. The calculation parameter storage unit M1 is configured such that data can be written, read, and deleted by the processor 21.

The external information acquisition unit F1 acquires various types of information related to a state of the host vehicle and the external environment from the vehicle state sensor 101 and the in-vehicle ECU 102. For example, the external information acquisition unit F1 may acquire information on a three-dimensional object present around the light distance measurement device 1 from the in-vehicle ECU 102 corresponding to the driving assistance ECU. The surrounding three-dimensional object can be specified based on an image analysis result of an in-vehicle camera that images the outside of the vehicle or an output signal of a sonar. For example, assuming a scene immediately before or immediately after parking, another parked vehicle, a wall, or the like may be present within several meters from the host vehicle. The controller 2 may determine whether a three-dimensional object is present in the vicinity region of the light distance measurement device 1 based on a detection result of an external environment by another sensor such as an in-vehicle camera or a sonar as reference information. The controller 2 may perform the distance calculation process preferentially using a light reception/emission result at a suppression level to be described later on condition that it is determined by another sensor that a three-dimensional object is present within a predetermined distance from the light distance measurement device 1.

The pulse information acquisition unit F2 acquires the pulse information from the peak detector 8 corresponding to each pixel. That is, the pulse information acquisition unit F2 acquires the pulse information for each pixel. Each pixel can be distinguished by a pixel number which is a unique number for each pixel. A part of the function of the peak detector 8 may be included in the pulse information acquisition unit F2. For example, the peak detector 8 may execute only the detection of the peak, and the pulse information acquisition unit F2 may execute the extraction processing of the feature amount of the received light pulse including the detected peak. The functional arrangement can be appropriately changed.

The level adjustment unit F3 adjusts the irradiation intensity of the sensing light. The level adjustment unit F3 switches the irradiation intensity from the normal level to the suppression level or from the suppression level to the normal level based on a switching pattern registered in advance. For example, the level adjustment unit F3 alternately switches between a state in which the level is set to the normal level and a state in which the level is set to the suppression level for each light-reception-emission process. This control mode corresponds to a configuration in which the light-reception-emission process at the normal level and the light-reception-emission process at the suppression level are alternately performed.

Hereinafter, for simplification of description, the light-reception-emission process at the normal level is also referred to as a normal process, and the light-reception-emission process at the suppression level is also referred to as a suppression process. Further, the pulse information acquired in the normal process is also referred to as normal pulse information, and the pulse information acquired in the suppression process is also referred to as suppression pulse information. Further, the peak arrival time Tp observed in the normal process is also referred to as a normal peak time Tp1, and the peak arrival time Tp observed in the suppression process is also referred to as a suppression peak time Tp2. The rise determination time Ta observed in the normal process is also referred to as a normal rise time Ta1, and the rise determination time Ta observed in the suppression process is also referred to as a suppression rise time Ta2. Further, the pulse width Tw observed in the normal process is also referred to as a normal pulse width Tw1, and the pulse width Tw observed in the suppression process is also referred to as a suppression pulse width Tw2.

The distance calculation unit F4 generates a distance value for each pixel based on the feature amount of the received light pulse for each pixel observed in the normal/suppression process. Details of the operation of the distance calculation unit F4 will be described later. The image generation unit F5 generates, as the distance image, a data set in which the distance value for each pixel calculated by the distance calculation unit F4 is assigned as an element value of each pixel. The image generation unit F5 may generate intensity image data that is a data set in which the peak intensity Pq detected by the peak detector 8 is associated with each pixel. The image generation unit F5 may generate image data in which each pixel includes the distance information and intensity information.

FIG. 10 is a flowchart illustrating an example of a flow of a distance measurement process in which the light distance measurement device 1 calculates the distance value in each pixel. The distance measurement process shown in FIG. 10 is performed at a predetermined sensing cycle on condition that the traveling power source is turned on. The sensing cycle can be set to, for example, 100 milliseconds or 200 milliseconds. In the present embodiment, the distance measurement process includes steps S101 to S106 as an example. The flowcharts in the present disclosure are all examples, and the number of steps, the processing order, the execution conditions, and the like can be changed as appropriate.

Step S101 is a step of executing a normal process. More specifically, the level adjustment unit F3 causes the irradiation unit 4 to irradiate the sensing light at the normal level in cooperation with the irradiation control circuit 3. In conjunction with this, the light receiving array 5 is set to a standby state. Of course, the light receiving array 5 may be always set to the standby state in which light can be detected. Further, the controller 2 may set the light receiving array 5 to the standby state prior to the irradiation of the sensing light. A response state of each light receiving cell 5s constituting the light receiving array 5 is input to the peak detector 8 via the adder 7 corresponding to each pixel. Each peak detector 8 generates the pulse information for each pixel based on the time-series data of the output value of the corresponding adder 7, and inputs the pulse information to the controller 2.

In step S102, the pulse information acquisition unit F2 acquires the pulse information for each pixel as a result of the normal process (that is, step S101). The pulse information includes predetermined types of feature amounts such as the peak arrival time Tp, the peak arrival time Tp, the rise determination time Ta, and the falling determination time Tb described above.

Step S103 is a step of executing the suppression process. More specifically, the level adjustment unit F3 causes the irradiation unit 4 to irradiate the sensing light at the suppression level in cooperation with the irradiation control circuit 3. In step S104, the pulse information acquisition unit F2 acquires the pulse information for each pixel as a result of the suppression process (that is, step S103).

In the normal process, the output level is likely to be saturated even with the unnecessary reflected light component, and it is difficult to distinguish which side of the target pulse the unnecessary reflected light component is coupled to. On the other hand, according to the suppression process, the output level is less likely to be saturated with the unnecessary reflected light component. According to the suppression process, different waveform outputs are obtained depending on whether the unnecessary reflected light coupled to the target reflected light is scattered light or multiple reflected light. That is, the controller 2 as the distance calculation unit F4 is capable of identifying the type of the unnecessary reflected light coupled to the target reflected light or a coupling position of the unnecessary reflected light based on the time-series data of the received light intensity at the suppression level. The coupling position of the unnecessary reflected light corresponds to whether the unnecessary reflected light is coupled to the front of the target reflected light or the rear of the target reflected light.

The normal process including step S101 and step S102 and the suppression process including step S103 and step S104 are different only in the irradiation intensity of the sensing light, and other signal processing can be the same. A combination of feature amounts acquired in each process may be the same or different. According to a configuration in which the same combination of feature amounts is acquired in each process, the operations of the peak detector 8 and the pulse information acquisition unit F2 can be made common in each process. In addition, criteria for selecting an observation pattern to be described later can be increased. Here, as an example, the combination of feature amounts to be extracted in the suppression process is set to be the same as the combination of feature amounts to be extracted in the normal process.

As another aspect, the number of feature amounts extracted in the suppression process may be set to be smaller than the number of feature amounts acquired in the normal process. In other words, in the suppression process, only a part of the feature amount extracted in the normal process may be extracted. For example, in the normal process, five items of the peak intensity Pq, the peak arrival time Tp, the rise determination time Ta, the falling determination time Tb, and the pulse width Tw are extracted. On the other hand, in the suppression process, three items of the peak arrival time Tp, the rise determination time Ta, and the falling determination time Tb may be extracted. The extraction target in the suppression process may be three items of the pulse width Tw, the rise determination time Ta, and the falling determination time Tb. According to the configuration in which the number of feature amounts to be extracted (calculated) in the suppression process is reduced compared to the normal process, calculation resources (time, memory, and the like) can be reduced.

In addition, although FIG. 10 shows a procedure in which the suppression process is executed after the normal process is executed, the execution order may be reversed. The normal process may be performed after the suppression process is performed. An execution interval between the normal process and the suppression process is set to a sufficiently small value, such as 1 millisecond or 10 milliseconds, so as to reduce the influence of a change in the periphery environment. The execution interval between the normal process and the suppression process may be set to be longer than a response waiting time which is a time for waiting for a response in the light receiving array 5.

Step S105 is a step of determining, for each pixel, the observation pattern of the received light pulse to be processed based on the pulse information observed in the normal process and the pulse information observed in the suppression process. The observation pattern is divided into, for example, (A) normal pattern, (B) multiple reflected light coupling pattern, and (C) scattered light coupling pattern. The normal pattern corresponds to a case where the target pulse is not coupled with the unnecessary reflected light. The multiple reflected light coupling pattern corresponds to a case where the target pulse is coupled with the multiple reflected light. The scattered light coupling pattern corresponds to a case where the target pulse is coupled with the proximity body scattered light. Step S105 corresponds to a step of identifying whether the received light pulse observed in the normal process is affected by the unnecessary reflected light, and identifying the type of the received light pulse when the received light pulse is affected, from the pulse information observed in the normal/suppression process. In one aspect, step S105 corresponds to determining whether the received light pulse is affected by the proximity body scattered light.

In step S106, the distance is calculated using the calculation formula corresponding to the observation pattern selected in step S105. the calculation formula for each observation pattern is registered in advance. The calculation formula for each observation pattern is individually designed so as to be suitable for whether the unnecessary reflected light is superimposed and the type of the superimposed unnecessary reflected light. The various calculation formula may use different feature amounts or the like. However, depending on the feature amount used for the calculation, the calculation formula in a case where it is determined that the observation pattern is normal and the calculation formula in a case where it is determined that the multiple reflected lights are combined may be integrated (shared). Details of the calculation formula for each observation pattern will be described later.

Steps S102, S104, S105, and S106 described above are executed for each pixel. In addition, the processes of steps S105 and S106 are processes for the received light pulse/peak detected at a common position in the normal process and the suppression process in the same pixel. The distance calculation unit F4 is capable of executing the above processing for each received light pulse observed in the normal process. The received light pulse to be processed is also referred to as a target pulse in the present disclosure.

The processing in step S105 and subsequent steps can be performed on the received light pulse/peak observed until an elapsed time from the irradiation of the sensing light reaches a vicinity time corresponding to the vicinity distance. The vicinity time can be set to, for example, a value obtained by dividing twice the vicinity distance by the speed of light. A time period from the emission of the sensing light to the vicinity time is also referred to as a vicinity time period.

The controller 2 may regard the peak as noise derived from the unnecessary reflected light and discard the peak when the peak observed in the vicinity time period as a result of the normal process is not observed in the suppression process. This is because, when a target is present in the vicinity region, there is a high possibility that the peak corresponding to the target is detected at a similar position even at the suppression level. The peak that is observed in the vicinity time period as a result of the normal process and is not observed in the suppression process can be regarded as the peak derived from the unnecessary reflected light. It is assumed that the reflected light from a target present at a far distance can be observed in the normal process but cannot be observed in the suppression process from the relationship of irradiation intensity. Therefore, for the received light pulse observed outside the vicinity time period as a result of the normal process, the controller 2 may not determine that the noise is not a noise derived from unnecessary reflected light even if the received light pulse cannot be detected at a corresponding position in the suppression process. With respect to the received light pulse observed outside the vicinity time period as a result of the normal process, it may be determined whether the received light pulse is noise using another algorithm.

### Example (1) of Calculation Formula for Each Observation Pattern

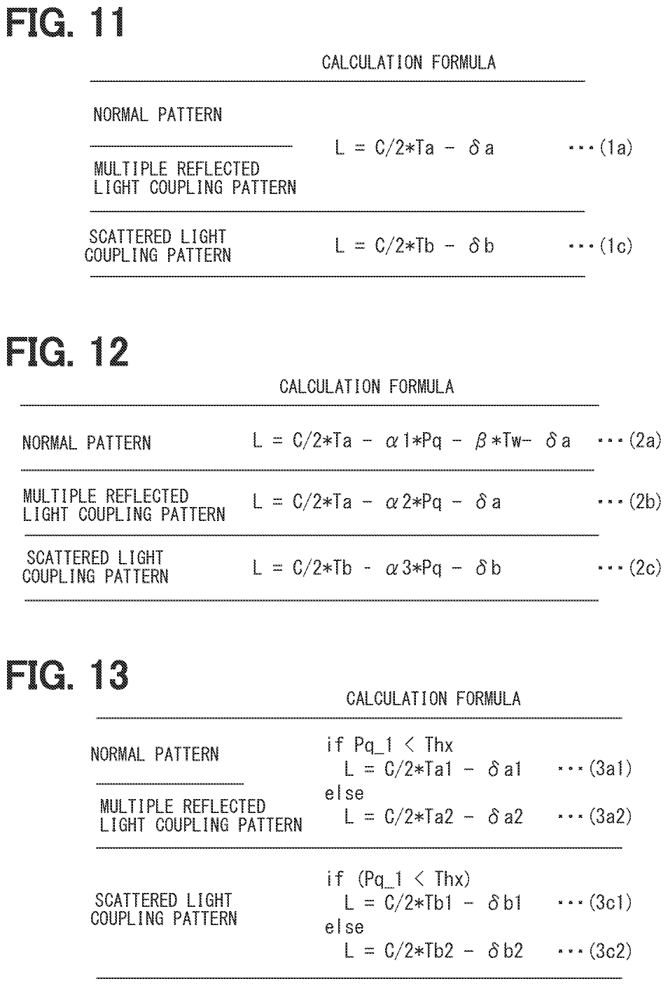

Next, the calculation formula for each observation pattern will be described. FIG. 11 is a diagram summarizing an example of a calculation formula applied to each observation pattern as one embodiment. In the present disclosure, the calculation method for the normal pattern is also referred to as a normal method, the calculation method for the multiple reflected light coupling pattern is also referred to as a multiple reflected light method, and the calculation method for the scattered light coupling pattern is also referred to as a scattered light method. Each calculation method is set to correspond to each of a case where there is no influence of the unnecessary reflected light, a case where there is an influence of the multiple reflected light, and a case where there is an influence of the scattered light.

Equation 1a shown in FIG. 11 is the calculation formula adopted in the normal pattern and the multiple reflected light coupling pattern. Equation 1c is the calculation formula adopted in the scattered light coupling pattern.

$$L = C / 2 \times Ta - δ a \qquad ( 1 a )$$

$$L = C / 2 \times Tb - δ b \qquad ( 1 c )$$

According to equation 1a applied to the normal pattern and the multiple reflected light coupling pattern, a value obtained by subtracting a predetermined rising offset value (δa) from a value obtained by multiplying the rise determination time (Ta) observed in the normal process by half the speed of light (C/2) is adopted as the distance value (L). The rising offset value (δa) used in equation 1a is a parameter for canceling (correcting) a response delay of the circuit or the like. The rising offset value (δa) can be appropriately designed. Further, in the scattered light method, as shown in equation 1c, a value obtained by subtracting a predetermined fall offset value (δb) from a value obtained by multiplying the fall determination time (Tb) observed in the normal process by half the light speed (C/2) is adopted as the distance value (L). The fall offset value (δb) is also a parameter for canceling a response delay of the circuit. The fall offset value is designed to be a value larger than the rising offset value so as to compensate for an error component derived from a time difference between the rise and fall of the received light pulse.

As described above, when the target reflected light is affected by the multiple reflected light, the falling point or the like is derived from the multiple reflected light, and thus may be incorrect information. Therefore, the distance is calculated based on the rising point as shown in equation 1a when the distance is affected by the multiple reflected light. On the other hand, at the time of the scattered light coupling, since the rising section is due to the scattered light component, the distance is calculated based on the falling point/upper limit deviation point. As described above, by adopting the calculation formula corresponding to the type of the unnecessary reflected light, accuracy of the distance can be improved.

### Example (2) of Calculation Formula for Each Observation Pattern

As another aspect, the controller 2 may adopt equation 2a to 2c as calculation formulas for each observation pattern. FIG. 12 is a diagram summarizing the calculation formulas for respective observation patterns. Equation 2a is a calculation formula for the normal pattern. Equation 2b is a calculation formula for the multiple reflected light coupling pattern. Equation 2c is a calculation formula for the scattered light coupling pattern.

$$L = C / 2 \times Ta - α 1 \times Pq - β \times Tw - δ a \qquad ( 2 a )$$

$$L = C / 2 \times Ta - α 2 \times Pq - δ a \qquad ( 2 b )$$

$$L = C / 2 \times Tb - α 3 \times Pq - δ b \qquad ( 2 c )$$

As the rise determination time Ta, the fall determination time Tb, the pulse width Tw, and the peak intensity Pq used in each of equations 2a to 2c, values observed in the normal process can be adopted. Coefficients α1, α2, and α3 are coefficients for performing correction according to the intensity of the received light pulse (that is, the peak intensity Pq). The coefficients α1, α2, and α3 may be set to different values. Coefficient β is a coefficient for performing correction according to the width of the received light pulse (that is, the pulse width Tw). The rising offset values (δa) used in equations 2a, 2b may be the same or different values may be applied.

The peak intensity Pq and the pulse width Tw indicate the shape of the received light pulse, in other words, the rising speed and the falling speed. It is experimentally known that there is a correlation between the intensity of the target reflected light and a deviation amount of a distance calculation value. Further, when the received light intensity is saturated, a relationship between the received light intensity and the true intensity of the target reflected light becomes unclear. However, it is experimentally known that there is a correlation between the intensity of the target reflected light and the pulse width. That is, the pulse width is as a parameter indirectly indicating the true intensity of the target reflected light. Therefore, when the observed received light pulse is not the target reflected light on which the unnecessary reflected light is superimposed, the distance measurement accuracy can be improved by introducing the correction value using the pulse width Tw. However, the pulse width Tw becomes a value deviated from the width of the target pulse when the target pulse is affected by the multiple reflected light or the proximity body scattered light. There is a concern that the distance measurement accuracy may be deteriorated when a correction term using the pulse width Tw is introduced under the influence of the multiple reflected light or the scattered light.

The above equations 2a to 2c are created based on the above concern, and in this method, the distance correction method is switched according to the observation pattern. According to this configuration, further improvement in distance measurement accuracy can be expected. The coupling in the present disclosure can be rephrased as overlapping.

### Example (3) of Calculation Formula for Each Observation Pattern

As still another aspect, as shown in FIG. 13, the controller 2 may adopt expressions 3a1, 3a2, 3c1, 3c2 as calculation formulas for each observation pattern. Equation 3a1 is a calculation formula applied when the normal peak intensity Pq1, which is the peak intensity Pq observed in the normal process, is less than a predetermined threshold Thx in the normal pattern and the multiple reflected light coupling pattern. Equation 3a2 is a calculation formula applied when the normal peak intensity Pq1 is equal to or greater than the threshold Thx in the normal pattern and the multiple reflected light combination pattern. Equation 3c1 is a calculation formula applied when the normal peak intensity Pq1 is less than the threshold Thx in the scattered light coupling pattern. Equation 3c2 is a calculation formula applied when the normal peak intensity Pq is equal to or greater than the threshold Thx in the scattered light coupling pattern.

The threshold Thx is, for example, the measurement upper limit value Pmx. The threshold value Thx may be 90% of the measurement upper limit value Pmx.

$$L = C / 2 \times Ta 1 - δ a 1 \qquad ( 3 a1 )$$

$$L = C / 2 \times Ta 2 - δ a 2 \qquad ( 3 a2 )$$

$$L = C / 2 \times Tb 1 - δ b 1 \qquad ( 3 c1 )$$

$$L = C / 2 \times Tb 2 - δ b 2 \qquad ( 3 c2 )$$

As described above, a value Ta1 included in equation 3a1 is the normal rise time. A value Ta2 included in equation 3a2 is a suppression rise time. A value δa1 included in equation 3a1, a value δa2 included in Equation 3a2 are rising offset values, and are parameters for canceling an error due to a delay time or the like required for rising. Different predetermined values can be set for δa1 and δa2.

Further, a value Tb1 included in equation 3c1 is a normal fall time, and Tb2 included in equation 3c2 is a suppressed fall time. A value δb1 included in equation 3c1 and a value δb2 included in equation 3c2 are rising offset values, and are parameters for canceling an error due to a delay time or the like required for rising. Different predetermined values can be set for δb1 and δb2.

The developers of the present disclosure have obtained knowledge that the distance accuracy may deteriorate in a case where the received light intensity is saturated during repeated tests and simulations. This is because the waveform of the target reflected light cannot be correctly sampled when saturation occurs. For example, the true peak value may be unclear when the received light intensity is saturated. The configuration using equation 3a1 is created based on the above knowledge, and the controller 2 calculates the distance based on the data of the suppression process when the received light intensity obtained in the normal process is equal to or greater than the threshold Thx. That is, the result of the suppression process in which saturation is relatively unlikely to occur is used when saturation occurs in the normal process. According to this configuration, effects of further improving the distance measurement accuracy can be expected.

In addition, although the aspect in which the distance calculation is performed using the rise determination time Ta or the falling determination time Tb as a main variable has been described above, the distance may be calculated using the peak arrival time Tp. The offset value such as da may be changed according to a feature amount used for the calculation processing. Further, a correction processing of the distance value using the peak intensity Pq and the pulse width Tw can also be applied to equations 3a to 3c described above.

### <Observation Pattern Discrimination Method (1)>

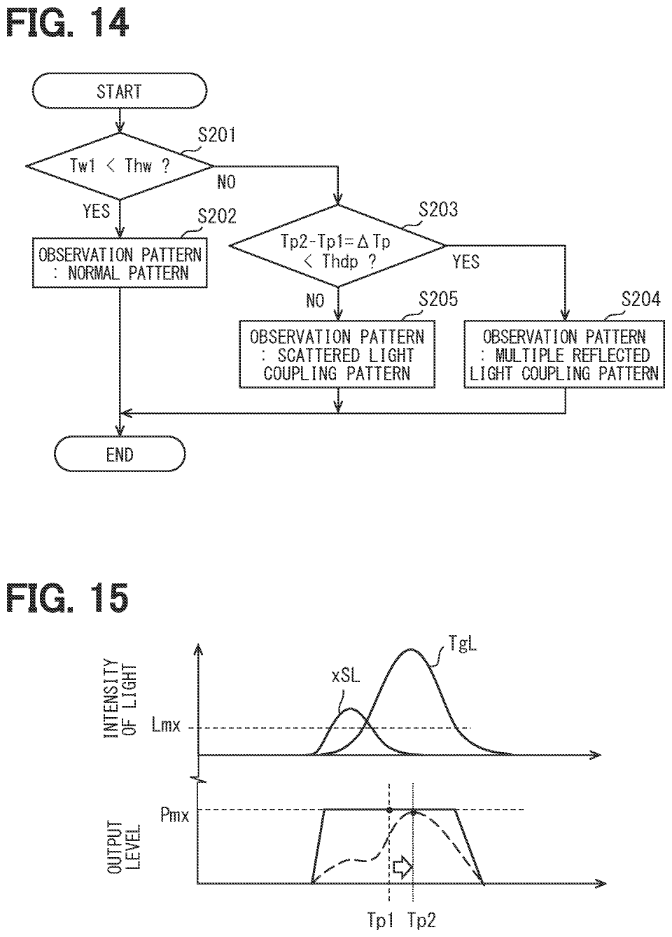

Next, a method of determining an observation pattern will be described with reference to FIG. 14. FIG. 14 is a flowchart illustrating an example of an observation pattern discrimination processing. The observation pattern determination process is executed as step S105 described above. Here, as an example, the observation pattern determination process includes steps S201 to S205. The processing of steps S201 to S205 is executed for each pixel. For convenience, a pixel to be processed is also referred to as a target pixel.

Step S201 is a step of determining whether the received light pulse observed in the normal process has a possibility that a component derived from the unnecessary reflected light is combined with the target pulse. For convenience, the received light pulse in which a component derived from the unnecessary reflected light is combined with the target pulse is also referred to as an unnecessary-reflected-light combined pulse. In addition, a process of determining whether the received light pulse is the unnecessary-reflected-light combined pulse as in step S201 or steps S301 and S401 described later is also referred to as an unnecessary-reflected-light determination process.

In step S201, for example, the distance calculation unit F4 determines whether the normal pulse width Tw1 is less than a predetermined pulse width threshold Thw. If the target reflected light is combined with the unnecessary reflected light, the normal pulse width Tw1 may be longer than a predetermined default value. Step S201 corresponds to a step of determining whether there is an influence of the unnecessary reflected light from the viewpoint of the pulse width. The pulse width threshold Thw is set to a value corresponding to the pulse width of the irradiation light. For example, the pulse width threshold Thw is set to 0.8 times, 1.0 times, 1.2 times, or the like the pulse width of the irradiation light.

The process proceeds to step S202, and it is determined that the observation pattern is the normal pattern when the normal pulse width Tw1 is less than the pulse width threshold Thw. Step S202 corresponds to a step of determining that the observed received light pulse is a target pulse that is not affected by the unnecessary reflected light. On the other hand, when the normal pulse width Tw1 is equal to or greater than the pulse width threshold Thw, step S203 is executed.

Step S203 corresponds to a step of identifying the type of the unnecessary reflected light combined (superimposed) with the target pulse based on a relationship between the normal peak time Tp1 and the suppression peak time Tp2. Note that, as a premise of step S203, the peak detector 8 adopts an intermediate time Tpc positioned between the upper limit arrival time Tpa and the upper limit deviation time Tpb as the peak arrival time Tp when the received light intensity reaches the measurement upper limit value Pmx.

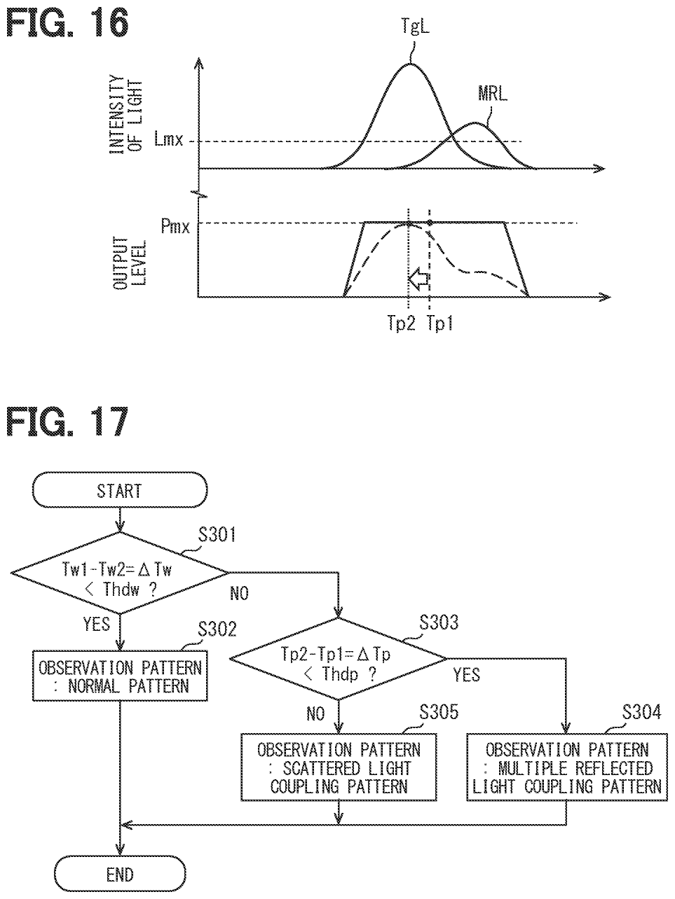

FIGS. 15, 16 are diagrams for explaining the technical idea of step S203. In a lower graphs of FIGS. 15, 16, a solid line graph indicates a transition of the output level by the normal process, and the broken line graph indicates a transition of the output level by the suppression process. When the proximity body scattered light is coupled to the target reflected light, as shown in FIG. 15, the suppression peak time Tp2 is later than the normal peak time Tp1. This is because, in the normal process, the received light intensity is saturated even in the proximity body scattered light component, and a value is calculated such that the normal peak time Tp1 is at a center point of the saturation period, that is, smaller than the true peak. Therefore, a fact that the value obtained by subtracting the normal peak time Tp1 from the suppression peak time Tp2 is positive suggests the possibility that the unnecessary reflected light (hereinafter referred to as coupled noise) coupled to the target reflected light is the proximity body scattered light.

Further, when the multiple reflected light is coupled to the target reflected light, as shown in FIG. 16, the suppression peak time Tp2 is smaller than the normal peak time Tp1. This is because the normal peak time Tp1 is located in the center of the saturation period and thus is calculated to be larger than the true peak. Therefore, a fact that the value obtained by subtracting the normal peak time Tp1 from the suppression peak time Tp2 is negative suggests the possibility that the coupling noise is the multiple reflected light.

Step S203 is created in view of the above tendency, and when the peak time difference ΔTp (=Tp2−Tp1) is less than a predetermined peak time difference threshold Thdp, it is determined that the coupling noise is the multiple reflected light. That is, when the peak time difference ΔTp is less than the peak time difference threshold Thdp, the process proceeds to step S204, and the observation pattern is determined to be the multiple reflected light coupling pattern. The peak time difference ΔTp is a value obtained by subtracting the normal peak time Tp1 from the suppression peak time Tp2.

On the other hand, when the peak time difference ΔTp is equal to or greater than the peak time difference threshold value Thdp, the coupling noise is regarded as the proximity body scattered light, and the observation pattern is determined as the scattered light coupling pattern (step S205). The peak time difference threshold Thdp used in step S203 may be 0, 0.5 nanoseconds, or the like. In addition, the peak time difference threshold Thdp may be dynamically determined according to the length of the saturation period obtained by subtracting the upper limit arrival time Tpa from the upper limit deviation time Tpb observed in the normal process. For example, the peak time difference threshold Thdp may be set to a value corresponding to 1% or 10% of the saturation time.

### <Observation Pattern Discrimination Method (2)>

Here, another example of a method of determining the observation pattern will be described with reference to FIG. 17. FIG. 17 is also a flowchart illustrating an example of the observation pattern determination process executed as step S105 described above. The observation pattern discrimination processing shown in FIG. 17 includes steps S301 to S305.

Step S301 corresponds to a step of determining whether the target reflected light is coupled with the unnecessary reflected light based on the pulse width change amount ΔTw which is a change amount (difference) between the normal pulse width Tw1 and the suppression pulse width Tw2. The pulse width change amount ΔTw is a value obtained by subtracting the suppression pulse width Tw2 from the normal pulse width Tw1.

The difference between the normal pulse width Tw1 and the suppression pulse width Tw2 can be expected to be equal to or less than a predetermined value when the target reflected light is not coupled with the unnecessary reflected light. On the other hand, the normal pulse width Tw1 may be longer than the suppression pulse width Tw2 by the coupling noise when the target reflected light is coupled with the unnecessary reflected light. Alternatively, the suppression pulse width Tw2 is likely to be a width of a component purely derived from the target reflected light, and can be a value smaller than the normal pulse width Tw1. That is, a fact that the pulse width change amount ΔTw is equal to or greater than the predetermined value suggests that an influence of the unnecessary reflected light is received.

Step S301 of the present disclosure is created based on the above idea. When the pulse width change amount ΔTw is less than the predetermined width difference threshold Thdw, the process proceeds to step S302, and the observation pattern is determined to be the normal pattern. Step S302 corresponds to a step of regarding the observed received light pulse as the target pulse that is not affected by the unnecessary reflected light.

On the other hand, when the pulse width change amount ΔTw is equal to or larger than the predetermined width difference threshold Thdw, step S303 is executed. Since the process of Step S303 to S305 is the same as that of the Step S203 to S205 described above, a description of the process will be omitted. A specific value of the width difference threshold Thdw used in the determination process of step S301 can be appropriately designed. The width difference threshold Thdw may be dynamically determined according to the normal pulse width Tw1 or the suppression pulse width Tw2. The width difference threshold Thdw may be a value obtained by multiplying the normal pulse width Tw1 by a predetermined coefficient (for example, 0.2).

### <Method of Discriminating Observation Pattern (3)>

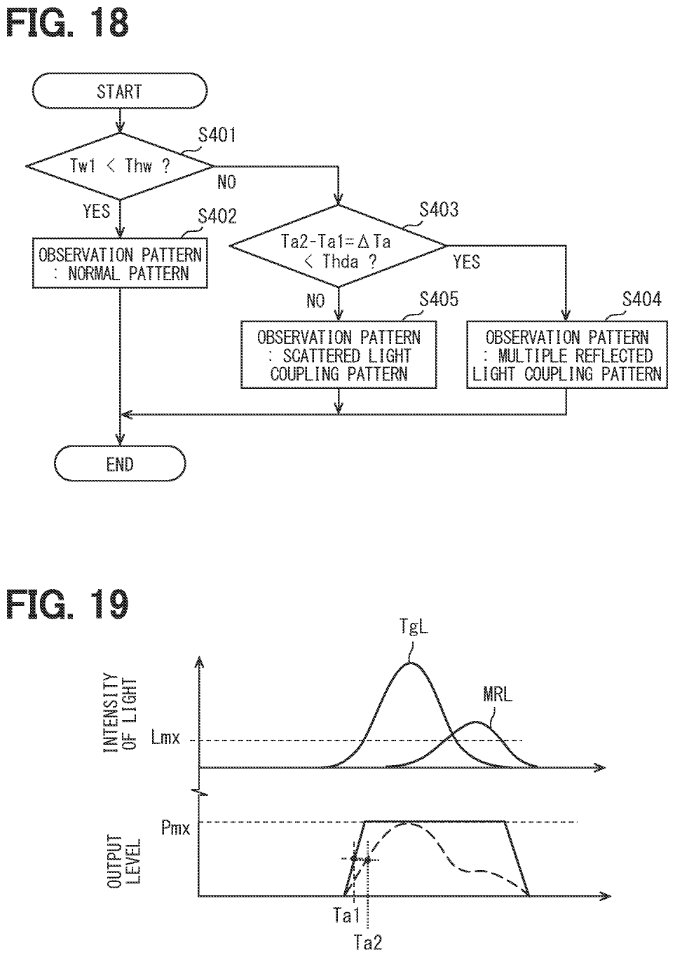

Here, another example of a method of determining the observation pattern will be described with reference to FIG. 18. FIG. 18 is also a flowchart illustrating an example of the observation pattern determination process executed as step S105 described above. The observation pattern discrimination processing illustrated in FIG. 18 includes steps S401 to S405.

Step S401 is a determination step similar to step S201 described above. The process proceeds to step S402, and it is determined that the observation pattern is the normal pattern when the normal pulse width Tw1 is less than the pulse width threshold Thw. On the other hand, when the normal pulse width Tw1 is equal to or greater than the pulse width threshold Thw, step S403 is executed.

Step S403 corresponds to a step of identifying the type of the coupled noise based on a rise time difference ΔTa, which is an amount of change (difference) between the normal rise time Ta1 and the suppression rise time Ta2. The rise time difference ΔTa is a value obtained by subtracting the normal rise time Ta1 from the suppression rise time Ta2.

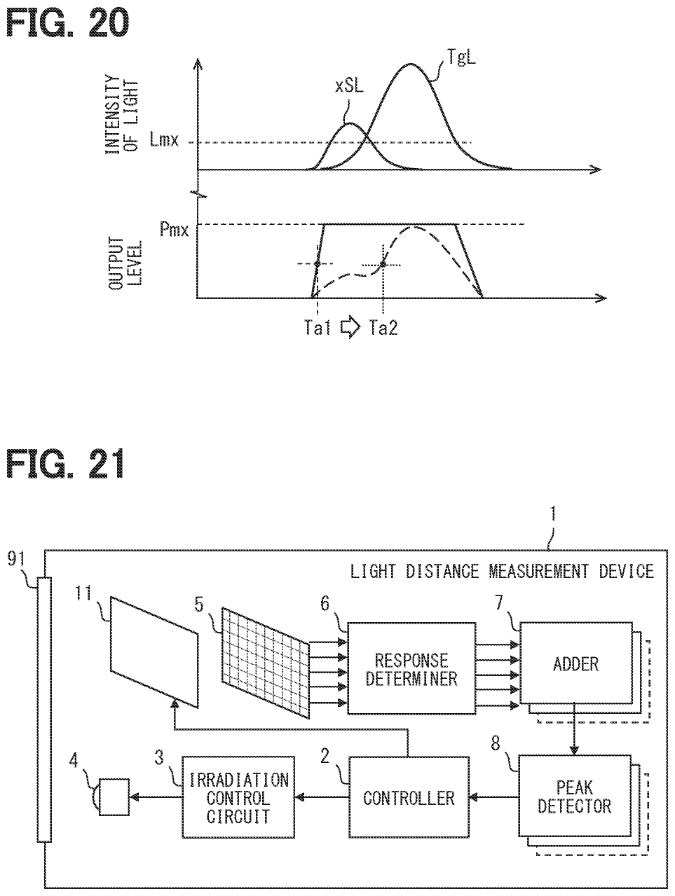

FIGS. 19, 20 are diagrams for explaining the technical idea of step S403. A solid line graphs in a lower graphs of FIGS. 19, 20 show a transition of the output level of the adder 7 by the normal process, and a broken line graphs show a transition of the output level of the adder 7 by the suppression process. When the multiple reflected light is coupled to the target reflected light, a difference between the suppression rise time Ta2 and the normal rise time Ta1 becomes a relatively small value as shown in FIG. 19. This is because the multiple reflected light is not coupled to a front of the target reflected light due to an optical path length. In other words, when the coupling noise is the multiple reflected light, the rising section is derived from the target reflected light in both the normal process and the suppression process, and thus the difference between the normal rise time Ta1 and the suppression rise time Ta2 is small.

On the other hand, when the target reflected light is combined with the proximity body scattered light component, the suppression rise time Ta2 can be longer than the normal rise time Ta1 by an amount corresponding to the proximity body scattered light, as shown in FIG. 20. This is because, when the coupling noise is the proximity body scattered light, the rising section in the normal process is derived from the proximity body scattered light as the coupling noise. When the coupling noise is the proximity body scattered light, the difference between the normal rise time Ta1 and the suppression rise time Ta2 is relatively large as compared with a case where the coupling noise is the multiple reflected light. That is, a fact that the rise time difference ΔTa is equal to or greater than the predetermined value suggests that there is an influence of the proximity body scattered light.

Step S403 of the present disclosure is created based on the above idea. When the rise time difference ΔTa is less than the predetermined rise time difference threshold Thda, the process proceeds to step S404, and the observation pattern is determined to be the multiple reflected light coupling pattern. Step S404 corresponds to a step of regarding that the observed received light pulse is affected by the multiple reflected light.

On the other hand, when the rise time difference ΔTa is equal to or greater than the rise time difference threshold Thda, the process proceeds to step S405, and the observation pattern is determined to be the scattered light coupling pattern. Step S405 corresponds to a step of regarding the coupling noise as the proximity body scattered light. The rising time difference threshold Thda used in step S403 may be a constant value such as 0.5 nanoseconds or 1.0 nanoseconds. In addition, the rise time difference threshold Thda may be dynamically determined according to the suppression peak intensity Pq2 which is the peak intensity Pq observed in the suppression process or the rising speed observed in the normal process. For example, as the rise time difference threshold Thda, a larger value may be applied as the suppression peak intensity Pq2 is smaller.

In one aspect, the above configuration corresponds to a configuration in which a feature amount used for the distance calculation is switched according to whether the time difference between the normal rise time Ta1 and the suppression rise time Ta2 is less than a predetermined value. That is, when the time difference between the normal rise time Ta1 and the suppression rise time Ta2 is less than the predetermined value, it is estimated that the coupling with the multiple reflected light occurs or the coupling with the unnecessary reflected light does not occur, and the distance is calculated based on the rise determination time Ta. On the other hand, it is estimated that the coupling with the proximity body scattered light occurs, and the distance is calculated based on the fall determination time Tb when the time difference between the normal rise time Ta1 and the suppression rise time Ta2 is equal to or larger than the predetermined value. The rise determination time Ta/fall determination time Tb used for the calculation may be an observation value in the normal process or an observation value in the suppression process. As described with reference to FIG. 13, the controller 2 may switch between the light-reception-emission processes to use the observation value based on the peak intensity Pq observed in the normal process.

The rise time difference ΔTa may be a value obtained by subtracting the suppression rise time Ta2 from the normal rise time Ta1, or may be an absolute value thereof. The rise time difference threshold Thda may be adjusted according to a definition of the rise time difference ΔTa.

In the above description, the type of the superimposed noise is determined based on the rise time difference ΔTa. However, a fall time difference can also be employed as a parameter for separating the type of the superimposed noise. The fall time difference is a difference between a normal fall time, which is the fall time Tb observed in the normal process, and a suppression fall time, which is the fall time Tb observed in the suppression process. When the superimposed noise is multiple reflected light, the fall time difference can be larger than that when the superimposed noise is the proximity body scattered light. Therefore, the controller 2 can determine that the superimposed noise is the multiple reflected light based on the fall time difference being equal to or greater than the predetermined value.

### Effects, etc.

In the light distance measurement device 1 described above, the controller 2 determines whether the received light pulse observed in the normal process is coupled with the unnecessary reflected light using the normal pulse width Tw1. Since the pulse width change amount ΔTw is also a parameter determined by the normal pulse width Tw1, a mode in which the controller 2 performs the determination based on the pulse width change amount ΔTw is also included in a configuration in which the presence or absence of coupling with the unnecessary reflected light is determined using the normal pulse width Tw1.

The normal pulse width Tw1 is a parameter that can be extracted by signal analysis, and a special circuit or the like for extracting the parameter is not newly required. Therefore, according to the above configuration, it is possible to determine whether the received light pulse is affected by the unnecessary reflected light without introducing a special configuration.

The normal pulse width Tw1 may vary depending on reflection characteristics of the target or the distance from the target. In view of such circumstances, it is practically difficult to determine the pulse width threshold Thw adaptable to all scenes. In addition, in a configuration in which the unnecessary reflected light coupling determination is performed by comparing the normal pulse width Tw1 with the pulse width threshold value Thw, depending on the situation, even though the pulse is an unnecessary-reflected-light combined pulse, the pulse may be regarded as not being the unnecessary-reflected-light combined pulse. With respect to such an issue, according to a configuration in which the unnecessary-reflected-light determination process is performed using the pulse width change amount ΔTw, erroneous determination derived from the distance to the target or the reflection characteristics can be reduced.

Further, the controller 2 identifies the type of the unnecessary reflected light coupled to the target reflected light based on the pulse information obtained by the normal process and the pulse information obtained by the suppression process. More specifically, the controller 2 uses the peak time difference ΔTp or the rise time difference ΔTa to determine whether the unnecessary reflected light coupled to the target reflected light is the proximity body scattered light. The distance value is calculated using the calculation formula/feature amount different from that of the normal pattern when it is determined that the unnecessary reflected light coupled to the target reflected light is the proximity body scattered light.

For example, in the normal pattern, the distance is calculated using the rise determination time Ta, whereas in the scattered light coupling pattern, the distance is calculated using the fall determination time Tb. Further, for example, the correction using the pulse width Tw is performed in the normal pattern, whereas the correction using the pulse width Tw is not performed in the scattered light coupling pattern. According to this configuration, the possibility that the distance to the target is calculated to be shorter than the actual value can be reduced due to the proximity body scattered light component.

Further, the controller 2 compares the pulse information obtained by the normal process with the pulse information obtained by the suppression process to determine whether the unnecessary reflected light coupled to the target reflected light is the multiple reflected light. The normal pulse width Tw1 is not used for the distance calculation when it is determined that the unnecessary reflected light coupled to the target reflected light is the multiple reflected light. According to this configuration, the possibility that the distance to the target is calculated to be longer than the actual value can be reduced due to the multiple reflected light component.

Further, in the above configuration, as an example, when the normal peak intensity Pq1 is less than the predetermined value, the distance calculation is performed using the feature amount obtained by the normal process, and when the normal peak intensity Pq1 is equal to or more than the predetermined value, the distance calculation is performed using the feature amount obtained by the suppression process. According to this configuration, the distance calculation is performed using the feature amount observed under a condition in which the saturation is relatively unlikely to occur. The longer the saturation period is, the more the ranging accuracy may deteriorate. According to the above configuration, the distance measurement accuracy can be improved.

Note that, as an assumed configuration which is another configuration for suppressing the erroneous calculation of the distance due to the influence of the unnecessary reflected light, a configuration in which the output intensity of the sensing light at the normal level is sufficiently weakened, in other words, a configuration in which only the suppression process is performed without performing the light-reception-emission process at the normal level is also considered. The assumed configuration can certainly reduce the possibility that the pixel value is saturated, and thus can be expected to reduce the influence of the unnecessary reflected wave. However, if the set value as the normal level is reduced to such an extent that the presence or absence of the coupling of the unnecessary reflected light can be determined, the distance measuring range becomes short. With respect to an issue of such an assumed configuration, according to the above embodiment, the accuracy of the distance value for each pixel can be improved while maintaining the distance measuring range.

While the embodiment of the present disclosure has been described above, the present disclosure is not limited to the embodiment described above. Various modifications to be described below are also included in the technical scope of the present disclosure. Besides the modifications to be described below, the present disclosure can be implemented with various changes without departing from the gist of the present disclosure. For example, various supplements and/or modifications to be described below can be implemented in combination as appropriate within a scope that does not cause technical inconsistency. The members having the same functions as described above are assigned the same reference numerals, and the description of the same members will be omitted. Further, when only a part of the configuration is mentioned, the above description can be applied to the other parts.

### <Configuration of Apparatus>

In the above description, an aspect in which the suppression process is realized by reducing the intensity of the irradiation light has been described, but the suppression process may be realized by reducing the detection sensitivity of the light reception system. For example, as shown in FIG. 21, the light distance measurement device 1 may include a transmittance adjustment panel 11 that is disposed in front of the light receiving array 5 and is capable of switching the transmittance. A liquid crystal panel can be employed as the transmittance adjustment panel 11. In this case, the level adjustment unit F3 dynamically switches the transmittance of the transmittance adjustment panel 11 between a predetermined normal level and a predetermined suppression level, thereby realizing the normal process and the suppression process. According to this configuration, it is not necessary to adjust the irradiation intensity. Of course, the light distance measurement device 1 may realize the normal process and the suppression process by executing the adjustment of the irradiation intensity and the adjustment of the light reception sensitivity (detection sensitivity) in parallel.

### <Behavior of Control Unit>

The light distance measurement device 1 is usually designed such that as little internally scattered light as possible reaches the light receiving array 5. Therefore, dirt (sand, soil, water droplets, snow, etc.) attached to the outside of the irradiation window 91 is substantially considered as a factor of the proximity body scattered light. These adhered matter 10 is accidentally attached and can be removed by cleaning. Therefore, the controller 2 may execute a cleaning process of cleaning the surface of the irradiation window 91 when it is determined that the superimposed noise is the proximity body scattered light. The cleaning process can include, for example, some or all of spraying of a cleaning liquid, driving of a wiper, and spraying of compressed air.

A fact that the proximity body scattered light is received corresponds to a fact that a part of the irradiation light is lost. There is a concern that the detection distance decreases when the intensity of the irradiation light is impaired. In view of such circumstances, the controller 2 may increase the irradiation intensity by a predetermined amount when it is determined that there is an influence of the proximity body scattered light. According to this configuration, even when the adhered matter 10 is attached to the irradiation window 91, the possibility that the detection distance decreases can be reduced.

In a case where it is determined that the influence of the proximity body scattered light is received, the controller 2 may output an alert signal indicating that the detection performance is impaired or the operation is not normally performed to the driving assistance ECU or the like. According to this configuration, the driving assistance ECU can perform a response such as limiting the traveling speed or transferring the driving authority to the driver based on the input of the alert signal. The alert signal may be a signal instructing stop or handover.

In addition, the controller 2 may display an image indicating that the detection performance is impaired or the detection device is not operating normally on the in-vehicle display, or may output the message as sound from the speaker when it is determined that there is an influence of the proximity body scattered light. According to this configuration, the occupant can easily recognize that the outer surface portion of the irradiation window 91 needs to be cleaned. As a result, measures such as stopping for cleaning can be quickly performed. That is, in the automatic operation device, it is easy to appropriately perform maintenance for normally functioning the system.

A notification destination of the influence of the proximity body scattered light is not limited to the occupant, and may be an operator outside the vehicle such as a center. The controller 2 may wirelessly transmit an alert signal to an external server/center/peripheral vehicle in cooperation with the in-vehicle communication device when it is determined that the influence of the proximity body scattered light is received.

Similarly, the controller 2 may transmit the alert signal to another ECU, an external server/center, or a peripheral vehicle when the multiple reflected light is detected. A content of the alert signal output when the multiple reflected light is detected may be the same as or different from that when the proximity body scattered light is detected. The content of the alert signal output when the multiple reflected light is detected may be a signal indicating that the distance accuracy/reliability is lowered.

In addition, the controller 2 may output an image or a voice message indicating that the distance accuracy/reliability is lowered when the multiple reflected light is detected. According to this configuration, the occupant can easily recognize an operation state of the light distance measurement device 1. Note that, as an example of the case of receiving the multiple reflected light, there is a case where a highly reflective object is present relatively close. The case where the multiple reflected light is detected can be rephrased as a case where a highly reflective object is present within a predetermined distance from the light distance measurement device 1. The highly reflective object is a retro-reflective object.

A signal indicating the presence of the highly reflective object may be input from an external device to the light distance measurement device 1 when an object defined as a highly reflective object is detected in a region near the light distance measurement device 1 by the external device by analyzing an image of an in-vehicle camera or the like. The light distance measurement device 1 may dynamically change the discriminant of the observation pattern based on the input signal from the outside. The light distance measurement device 1 may change the setting values of various thresholds related to the determination of the observation pattern so as to easily determine that the multiple reflected light is received when the light distance measurement device 1 is notified of the presence of a highly reflective object from the outside.

The device, the system, and the method therefor which have been described in the present disclosure may be also realized by a dedicated computer which constitutes a processor programmed to execute one or more functions implemented by computer programs. The device and the method described in the present disclosure may be implemented using a dedicated hardware logic circuit. Furthermore, the device and the method thereof described in the present disclosure may be implemented by one or more dedicated computers including a combination of a processor that executes a computer program and one or more hardware logic circuits. For example, part or all of the functions included in the light distance measurement device 1 may be implemented as hardware. A configuration in which a certain function is implemented by hardware includes a configuration in which the function is implemented by use of one or more ICs or the like. As the processor (arithmetic core), a CPU, an MPU, a GPU, a DFP (Data Flow Processor), or the like can be adopted. Further, a part or all of the functions of the light distance measurement device 1 may be implemented by a combination of multiple types of arithmetic processing devices. Some or all of the functions provided by the light distance measurement device 1 may be realized by using a system-on-chip (SoC), FPGA, ASIC, or the like. The FPGA is an abbreviation for Field Programmable Gate Array. The ASIC is an abbreviation of Application Specific Integrated Circuit.

Further, the computer program may be stored in a computer-readable non-transitionary tangible storage medium as an instruction executed by the computer. As a program storage medium, an HDD (Hard-disk Drive), an SSD (Solid State Drive), a flash memory, or the like can be adopted.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A light distance measurement device configured to detect a distance to a target by using a round-trip time of light to the target, the light distance measurement device comprising:
an irradiation unit configured to irradiate sensing light, which is light having a predetermined wavelength, in a predetermined detection target direction;
photodetectors arranged in a matrix and configured to respond to the sensing light;
a level adjustment unit configured to change an irradiation intensity of the sensing light output from the irradiation unit or detection sensitivity of the photodetectors from a normal level to a suppression level smaller than the normal level by a predetermined amount;
a peak detection unit configured to detect a received light pulse corresponding to reflected light which is the sensing light reflected by an object and returned, and a peak of the received light pulse, based on time-series data of a number of responses of the photodetector;
a pulse information acquisition unit configured to acquire, as pulse information, a data set indicating a predetermined feature amount related to the received light pulse detected by the peak detection unit, the pulse information including normal pulse information at the normal level and suppression pulse information at the suppression level; and
a distance calculation unit configured to calculate a distance value to the target based on the normal pulse information and the suppression pulse information.

2. The light distance measurement device according to claim 1, wherein
the normal pulse information includes a pulse width,
the distance calculation unit is configured to:
determine whether a target pulse, which is the received light pulse to be processed, is a combination of the reflected light from the target and unwanted reflected light based on the pulse width included in the normal pulse information for the target pulse; and
change at least one of a calculation formula and a feature amount for calculating the distance value according to whether the target pulse is a combination of the reflected light from the target and the unnecessary reflected light.

3. The light distance measurement device according to claim 2, wherein
the distance calculation unit is configured to determine that the target pulse is the combination of the reflected light from the target and the unnecessary reflected light based on the pulse width included in the normal pulse information for the target pulse being equal to or greater than a predetermined value.

4. The light distance measurement device according to claim 2, wherein
the suppression pulse information includes the pulse width, and
the distance calculation unit is configured to determine that the target pulse is the combination of the reflected light from the target and the unnecessary reflected light, based on a difference between the pulse width included in the normal pulse information and the pulse width included in the suppression pulse information for the target pulse being equal to or greater than a predetermined value.

5. The light distance measurement device according to claim 2, wherein
the distance calculation unit is configured to:
determine a type of the unnecessary reflected light by comparing the normal pulse information and the suppression pulse information for the target pulse when it is determined that the target pulse is the combination of the reflected light from the target and the unnecessary reflected light; and
change at least one of the calculation formula and the feature amount used for calculating the distance value according to the determined type of the unnecessary reflected light.

6. The light distance measurement device according to claim 5, wherein
each of the normal pulse information and the suppression pulse information includes a peak arrival time which is a time from irradiation of the sensing light to observation of a peak, and
the distance calculation unit is configured to determine the type of the unnecessary reflected light by comparing the peak arrival time included in the normal pulse information for the target pulse and the peak arrival time included in the suppression pulse information when it is determined that the target pulse is the combination of the reflected light from the target and the unnecessary reflected light.

7. The light distance measurement device according to claim 6, wherein
each of the normal pulse information and the suppression pulse information further includes a rise determination time indicating a timing at which intensity of the received light pulse is equal to or greater than a threshold value and a fall determination time indicating a timing at which the intensity of the received light pulse is equal to or lower than the threshold value, and
the distance calculation unit is configured to:
determine whether the unnecessary reflected light is proximity body scattered light, which is scattered light caused by an adhered matter on an irradiation window or scattered light inside a housing, by comparing the peak arrival time included in the normal pulse information for the target pulse and the peak arrival time included in the suppression pulse information;
calculate the distance value using the fall determination time when it is determined that the unnecessary reflected light is the proximity body scattered light; and
calculate the distance value using the rise determination time when it is determined that the unnecessary reflected light is not the proximity body scattered light.

8. The light distance measurement device according to claim 5, wherein
each of the normal pulse information and the suppression pulse information includes a rise determination time indicating a timing at which the intensity of the received light pulse is equal to or greater than the threshold value, and
the distance calculation unit is configured to determine the type of the unnecessary reflected light by comparing the rise determination time included in the normal pulse information and the rise determination time included in the suppression pulse information for the target pulse when it is determined that the target pulse is the combination of the reflected light from the target and the unnecessary reflected light.

9. The light distance measurement device according to claim 8, wherein
each of the normal pulse information and the suppression pulse information further includes a fall determination time indicating a timing at which the intensity of the received light pulse is equal to or less than the threshold value, and
the distance calculation unit is configured to:
determine whether the unnecessary reflected light is proximity body scattered light, which is scattered light caused by an adhered matter on an irradiation window or scattered light inside a housing, by comparing the rise determination time included in the normal pulse information for the target pulse and the fall determination time included in the suppression pulse information;
calculate the distance value using the fall determination time when it is determined that the unnecessary reflected light is the proximity body scattered light; and
calculate the distance value using the rise determination time when it is determined that the unnecessary reflected light is not the proximity body scattered light.

10. The light distance measurement device according to claim 2, wherein
the distance calculation unit is configured to:
determine whether the unnecessary reflected light is proximity body scattered light, which is scattered light caused by an adhered matter on an irradiation window or scattered light inside a housing, by comparing the normal pulse information for the target pulse and the suppression pulse information when it is determined that the target pulse is the combination of the reflected light from the target and the unnecessary reflected light; and
change at least one of the calculation formula and the feature amount for calculating the distance value according to whether the unnecessary reflected light is the proximity body scattered light.

11. The light distance measurement device according to claim 2, wherein
the normal pulse information includes a rise determination time indicating a timing at which the intensity of the received light pulse is equal to or greater than the threshold value, and
the distance calculation unit is configured to calculate the distance value using the rise determination time included the normal pulse information when it is determined that the target pulse is the reflected light from the target to which the unnecessary reflected light is not combined.

12. The light distance measurement device according to claim 11, wherein
the distance calculation unit is configured to determine the distance value by correcting a value, which is obtained by multiplying the rise determination time by half of the speed of light, according to the pulse width when it is determined that the target pulse is the reflected light from the target to which the unnecessary reflected light is not combined, and
the distance calculation unit is configured not to perform the correction using the pulse width when it is determined that the target pulse is the combination of the reflected light from the target and the unnecessary reflected light.

13. The light distance measurement device according to claim 1, wherein
the normal pulse information includes peak intensity indicating intensity at a peak, and
the distance calculation unit is configured to:
calculate the distance value using the suppression pulse information when the peak intensity included in the normal pulse information is equal to or greater than a predetermined value; and
calculate the distance value using the normal pulse information when the peak intensity included in the normal pulse information is less than the predetermined value.

14. The light distance measurement device according to claim 1, wherein
each of the normal pulse information and the suppression pulse information includes a rise determination time indicating a timing at which the intensity of the received light pulse is equal to or greater than the threshold value, and
the distance calculation unit is configured to change at least one of the calculation formula and the feature amount for calculating the distance value according to whether a rise time difference is less than a predetermined value, the rise time difference being a difference between the rise determination time included in the normal pulse information and the rise determination time included in the suppression pulse information for a target pulse, which is the received light pulse to be processed.

15. The light distance measurement device according to claim 14, wherein
each of the normal pulse information and the suppression pulse information further includes at least one of a fall determination time indicating a timing at which the intensity of the received light pulse is equal to or less than the threshold value and a peak arrival time which is a time from irradiation of the sensing light to observation of a peak, and
the distance calculation unit is configured to:
calculate the distance value using the rise determination time when the rise time difference is less than a predetermined value; and
calculate the distance value using a parameter other than the rise determination time when the rise time difference is equal to or greater than the predetermined value.

16. The light distance measurement device according to claim 1, wherein
the distance calculation unit is configured to determine that the received light pulse is the unnecessary reflected light when the received light pulse observed within a predetermined time after the sensing light is irradiated at the normal level is not observed when the suppression level is applied.

17. The light distance measurement device according to claim 1, wherein
the distance calculation unit is configured to:
detect the adhered matter on the irradiation window by comparing the normal pulse information and the suppression pulse information; and
perform a process for cleaning the irradiation window when the adhered matter is detected.

18. The light distance measurement device according to claim 1, wherein
the distance calculation unit is configured to:
detect the adhered matter on the irradiation window by comparing the normal pulse information and the suppression pulse information; and
perform a process of notifying an occupant, an operator present outside a vehicle, or another device that the adhered matter is present when the adhered matter is detected.

19. The light distance measurement device according to claim 1, wherein
the distance calculation unit is configured to:
determine whether multiple reflected light is likely to be received by comparing the normal pulse information and the suppression pulse information; and
perform a process of notifying the occupant, the operator present outside the vehicle, or another device that accuracy of distance measurement to the target is reduced when it is determined that the multiple reflected light is likely to be received.
